(19) United States
(12) Patent Application Publication
(10) Pub. No.: US 2014/0241301 A1
(43) Pub. Date: Aug. 28, 2014

(54) MOBILE STATION APPARATUS, COMMUNICATION SYSTEM, COMMUNICATION METHOD, AND INTEGRATED CIRCUIT

(71) Applicants: Daiichiro Nakashima, Osaka-shi (JP); Wataru Ouchi, Osaka-shi (JP); Shoichi Suzuki, Osaka-shi (JP); Kimihiko Imamura, Osaka-shi (JP); Yosuke Akimoto, Osaka-shi (JP); Katsunari Uemura, Osaka-shi (JP); Yasuyuki Kato, Osaka-shi (JP)

(72) Inventors: Daiichiro Nakashima, Osaka-shi (JP); Wataru Ouchi, Osaka-shi (JP); Shoichi Suzuki, Osaka-shi (JP); Kimihiko Imamura, Osaka-shi (JP); Yosuke Akimoto, Osaka-shi (JP); Katsunari Uemura, Osaka-shi (JP); Yasuyuki Kato, Osaka-shi (JP)

(73) Assignee: SHARP KABUSHIKI KAISHA, Osaka-shi, Osaka (JP)

(21) Appl. No.: 14/347,900

(22) PCT Filed: Aug. 13, 2012
(86) PCT No.: PCT/JP2012/070606

§ 371 Date: Mar. 27, 2014

(30) Foreign Application Priority Data
Sep. 28, 2011 (JP) 2011-211771

(51) Int. Cl. H04W 52/32; H04W 52/24

(52) U.S. Cl. CPC H04W 52/325; H04W 52/242
USPC 370/329

(57) ABSTRACT

In a communication system including multiple mobile station apparatuses and at least one base station apparatus, the base station apparatus efficiently controls transmission of an uplink signal to the mobile station apparatuses. A path loss calculator calculates path loss on the basis of a reference signal received by a reception processing unit. A transmit power setter sets desired transmit power of an uplink signal using the path loss calculated by the path loss calculator. Additionally, a power head room controller generates power head room that is information concerning a margin of the transmit power using the desired transmit power set in the transmit power setter to control transmission of the power head room. The power head room controller determines to transmit the power head room upon switching of a kind of the reference signal used in the calculation in the path loss calculator.

### TECHNICAL FIELD

The present invention relates to a mobile station apparatus, a communication system, a communication method, and an integrated circuit, which are capable of realizing efficient transmission of an uplink signal in the communication system including multiple mobile station apparatuses and a base station apparatus.

### BACKGROUND ART

Radio access methods in cellular mobile communication and evolution of radio networks (hereinafter referred to as “Long Term Evolution (LTE) or “Evolved Universal Terrestrial Radio Access (EUTRA)”) are specified in a 3rd Generation Partnership Project (3GPP). In the LTE, an orthogonal frequency division multiplexing (OFDM) method, which is multi-carrier transmission, is used as a communication method for radio communication from a base station apparatus to each mobile station apparatus (referred to as a downlink (DL)). In the LTE, a single-carrier frequency division multiple access (SC-FDMA) method, which is single-carrier transmission, is used as a communication method for radio communication from each mobile station apparatus to a base station apparatus (referred to as an uplink (UL). In the LTE, a discrete Fourier transform-Spread OFDM (DFT-Spread OFDM) method is used as the SC-FDMA method.

In the 3GPP, radio access methods and radio networks realizing high-speed data communication, compared with the LTE, (hereinafter referred to as “Long Term Evolution-Advanced (LTE-A)” or “Advanced Evolved Universal Terrestrial Radio Access (A-EUTRA)”) are discussed. In the LTE-A, it is required to realize backward compatibility with the LTE. It is required for the LTE-A to realize simultaneous communication of the base station apparatus supporting the LTE-A with both the mobile station apparatus supporting the LTE-A and the mobile station apparatus supporting the LTE and communication of the mobile station apparatus supporting the LTE-A with the base station apparatus supporting the LTE-A and the base station apparatus supporting the LTE.

In order to realize the above request, support of at least the same channel structure as that of the LTE is discussed in the LTE-A. The channel means a medium used for transmission of signals. The channel used in a physical layer is referred to as a physical channel and the channel used in a medium access control (MAC) layer is referred to as a logical channel. Kinds of the physical channel include a physical downlink shared channel (PDSCH) used for transmission and reception of downlink data and control information, a physical downlink control channel (PDCCH) used for transmission and reception of downlink control information, a physical uplink shared channel (PUSCH) used for transmission and reception of uplink data and control information, a physical uplink control channel (PUCCH) used for transmission and reception of control information, a synchronization channel (SCH) used for establishment of downlink synchronization, a physical random access channel (PRACH) used for establishment of uplink synchronization, and a physical broadcast channel (PBCH) used for transmission of downlink system information. The mobile station apparatus or the base station apparatus arranges a signal generated from, for example, the control information or the data on each physical channel to transmit the signal. The data transmitted on the physical downlink shared channel or the physical uplink shared channel is referred to as a transport block.

The control information arranged on the physical uplink control channel is referred to as uplink control information (UCI). The uplink control information is control information indicating acknowledgement (ACK) or negative acknowledgement (NACK) for the data that is received and that is arranged on the physical downlink shared channel (a reception confirmation response (ACK/NACK)), control information indicating a request for allocation of an uplink resource (scheduling request (SR)), or control information indicating downlink reception quality (also referred to as channel quality) (channel quality indicator (CQI)).

### <Cooperative Multipoint Communication>

In the A-EUTRA, cooperative multipoint communication (CoMP communication) in which adjacent cells cooperatively communicate with each other is discussed in order to reduce or suppress interference to the mobile station apparatuses in a cell edge area or to increase receive signal power. For example, a communication mode of the base station apparatus using one arbitrary frequency band is referred to as a “cell.” For example, a method in which different weights are applied to signals in weighted signal processing (precoding processing) in multiple cells and multiple base station apparatuses cooperatively transmit the signals to the same mobile station apparatus (also referred to as joint processing or joint transmission) is discussed as the cooperative multipoint communication. With this method, it is possible to improve a ratio of signal power to interference noise power of the mobile station apparatus to improve reception property in the mobile station apparatus. For example, a method in which multiple cells cooperatively perform scheduling of the mobile station apparatuses (coordinated scheduling (CS)) is discussed as the cooperative multipoint communication. With this method, it is possible to improve the ratio of signal power to interference noise power of the mobile station apparatus. For example, a method in which multiple cells cooperatively apply beamforming to transmit signals to the mobile station apparatuses (coordinated beamforming (CB)) is discussed as the cooperative multipoint communication. With this method, it is possible to improve the ratio of signal power to interference noise power of the mobile station apparatus. For example, a method in which only one cell transmits a signal using a certain resource and the other cell does not transmit a signal using the certain resource (blanking or muting) is discussed as the cooperative multipoint communication. With this method, it is possible to improve the ratio of signal power to interference noise power of the mobile station apparatus.

As for the multiple cells used in the cooperative multipoint communication, different cells may be composed of different base station apparatuses, different cells may be composed of different remote radio heads (RRHs: outdoor radio units smaller than the base station apparatus, also referred to as remote radio units (RRUs)) managed by the same base station apparatus, different cells may be composed of a base station apparatus and the RRHs managed by the base station apparatus, or different cells may be composed of a base station apparatus and the RRHs managed by another different base station apparatus.

The base station apparatus having wider coverage is generally referred to as a macro base station apparatus. The base station apparatus having narrower coverage is generally referred to as a pico base station apparatus or a femto base station apparatus. The operation of the RRHs is generally discussed in an area the coverage of which is narrower than that of the macro base station apparatus. Development of, for example, a communication system which is composed of the macro base station apparatus and the RRHs and in which the coverage supported by the macro base station apparatus includes part of the coverage or the entire coverage supported by the RRHs is referred to as heterogeneous network development. A method in which the macro base station apparatus and the RRHs cooperatively transmit signals to the mobile station apparatus the coverage area of which is overlapped with the coverage areas of the macro base station apparatus and the RRHs is discussed in the communication system of the heterogeneous network development. The RRHs are managed by the macro base station apparatus and transmission and reception from and to the RRHs are controlled by the macro base station apparatus. The macro base station apparatus and the RRHs are connected to each other via a wired line, such as optical fiber, or a radio network using a relay technology. The cooperative multipoint communication between the macro base station apparatus and the RRHs using the radio resources that are partially equal to each other or that are equal to each other allows the overall frequency use efficiency (transmission capacity) within the coverage area built by the macro base station apparatus to be improved.

The mobile station apparatus is capable of single-cell communication with the macro base station apparatus or the RRH if the mobile station apparatus is positioned near the macro base station apparatus or the RRH. In other words, a certain mobile station apparatus communicates with the macro base station apparatus or the RRH without using the cooperative multipoint communication to transmit and receive signals to and from the macro base station apparatus or the RRH. For example, the macro base station apparatus receives an uplink signal from the mobile station apparatus close to the macro base station apparatus. For example, the RRH receives an uplink signal from the mobile station apparatus close to the RRH. In addition, if the mobile station apparatus is positioned near the edge (at the cell edge) of the coverage built by the RRH, it is necessary for the mobile station apparatus to take an action against interference on the same channel from the macro base station apparatus. A method in which the CoMP method in which adjacent base stations cooperate with each other is used to reduce or suppress the interference to the mobile station apparatuses in the cell edge area is discussed as multi-cell communication (the cooperative multipoint communication) between the macro base station apparatus and the RRHs.

A method in which the mobile station apparatus receives signals transmitted from both the macro base station apparatus and the RRH using the cooperative multipoint communication on the downlink and transmits a signal to either of the macro base station apparatus and the RRH in an appropriate form on the uplink is discussed. For example, the mobile station apparatus transmits the uplink signal with transmit power appropriate for the reception of the signal by the macro base station apparatus. For example, the mobile station apparatus transmits the uplink signal with transmit power appropriate for the reception of the signal by the RRH. This allows unnecessary interference on the uplink to be reduced to improve the frequency use efficiency.

Estimation of path loss from each of multiple kinds of reference signals by the mobile station apparatus to set a transmit power parameter appropriate for the reception of the signal by the macro base station apparatus or the RRH is discussed (NPL 1). For example, the mobile station apparatus calculates the transmit power parameter appropriate for the reception of the signal by the macro base station apparatus from the reference signal transmitted from the macro base station apparatus. For example, the mobile station apparatus calculates the transmit power parameter appropriate for the reception of the signal by the RRH from the reference signal transmitted from the RRH. For example, the mobile station apparatus calculates the transmit power parameter semi-optimal for the reception of the signal by the macro base station apparatus or the RRH from the reference signal cooperatively transmitted from both the macro base station apparatus and the RRH. Specifically, the mobile station apparatus estimates the path loss on the basis of the reception quality of the received reference signal.

In addition, the mobile station apparatus notifies the base station apparatus of a value resulting from subtraction a transmit power value used for the transmission of the uplink signal from a maximum possible transmit power value, which is referred to as power head room (PH), in order to indicate to the base station apparatus how much room from the maximum transmit power value (the maximum possible transmit power value), which can be used as the apparatus capacity, the mobile station apparatus transmits the uplink signal with.

At the power head room, a value within a range from −23 dB to 40 dB is indicated and the value is represented in units of decibels. The power head room indicating a positive value indicates that the transmit power of the mobile station apparatus has room. The power head room indicating a negative value indicates a state in which, although the mobile station apparatus is requested from the base station apparatus to have a transmit power value exceeding the maximum possible transmit power value, the mobile station apparatus transmits the signal at the maximum possible transmit power value. The base station apparatus uses information about the power head room to adjust or determine the frequency bandwidth of the resource to be allocated to the uplink signal of the mobile station apparatus, a modulation method of the uplink signal, and so on.

The mobile station apparatus controls the transmission of the power head room using two timers: periodicPHR-Timer and prohibitPHR-Timer indicated from the base station apparatus and one value dl-PathlossChange (represented in units of decibels) indicated from the base station apparatus. The mobile station apparatus determines to transmit the power head room if any of events described below occurs. A first event is “a case in which prohibitPHR-Timer timer is terminated and the value of the path loss is varied from the value of the path loss used in the calculation when the power head room is transmitted last time by an amount exceeding dl-PathlossChange [db].” A second event is “a case in which periodicPHR-Timer timer is terminated.” A third event is “a case in which a matter concerning the transmission function of the power head room is set or re-set.” A process in which whether the power head room is transmitted is determined to report the power head room to the base station apparatus in the above manner is referred to as power head room reporting.

Upon determination of the transmission of the power head room and allocation of the resource used in the transmission of the uplink signal by the base station apparatus, the mobile station apparatus transmits the uplink signal including the information about the power head room to the base station apparatus. Upon transmission of the information about the power head room, the mobile station apparatus temporarily resets periodicPHR-Timer timer or prohibitPHR-Timer timer that is being measured and restarts periodicPHR-Timer timer or the prohibitPHR-Timer timer.

### CITATION LIST

### Non Patent Literature

NPL 1: 3GPP TSG RANI #66, Athens, Greece, 22-26, Aug. 2011, R1-112523 “UL PC for Networks with Geographically Distributed RRHs”

### SUMMARY OF INVENTION

### Technical Problem

However, only the case in which the path loss of one kind is estimated from the reference signal of one kind and the estimated path loss of one kind is used for the transmit power of the uplink signal is supposed in the related art concerning the power head room. For example, how to control the transmission of the power head room using the path loss estimated on the basis of the reference signal of one kind, among the reference signals of multiple kinds, is disclosed in no literature in the related art. For example, how to control the transmission of the information about the power head room when the path loss of multiple kinds are estimated from the reference signals of multiple kinds and the mobile station apparatus transmits the uplink signal with the transmit power calculated from each path loss is disclosed in no literature in the related art.

Without appropriate transmission of the information about the power head room to the base station apparatus, it is not possible to efficiently perform the allocation of the resource of the uplink signal to the mobile station apparatus, the determination of the modulation method, and so on to disadvantageously degrade the accuracy of the uplink scheduling.

In order to resolve the above problems, the present invention provides a mobile station apparatus, a communication system, a communication method, and an integrated circuit, which are capable of realizing efficient transmission of an uplink signal in the communication system including multiple mobile station apparatuses and a base station apparatus.

### Solution to Problem

(1) In order to achieve the above object, the present invention takes the following measures. Specifically, a mobile station apparatus of the present invention communicates with at least one base station apparatus. The mobile station apparatus includes a first reception processing unit that receives a signal from the base station apparatus; a path loss calculating unit that calculates path loss on the basis of a reference signal received by the first reception processing unit; a transmit power setting unit that sets desired transmit power of an uplink signal using the path loss calculated by the path loss calculating unit; and a power head room control unit that generates power head room that is information concerning a margin of the transmit power using the desired transmit power set by the transmit power setting unit to control transmission of the power head room. The power head room control unit determines to transmit the power head room upon switching of a kind of the reference signal used in the calculation in the path loss calculating unit.

(2) In the mobile station apparatus of the present invention, the reference signal is of a kind of either of a Cell specific Reference Signal (CRS) and a Channel State Information Reference Signal (CSI-RS).

(3) In the mobile station apparatus of the present invention, the reference signals of different kinds are Channel State Information Reference Signals (CSI-RSs) of different configurations.

(4) A communication system of the present invention includes multiple mobile station apparatuses and at least one base station apparatus communicating with the multiple mobile station apparatuses. The base station apparatus includes a second transmission processing unit that transmits a signal to the mobile station apparatuses; and a second reception processing unit that receives a signal from the mobile station apparatuses. The mobile station apparatuses each includes a first reception processing unit that receives a signal from the base station apparatus; a path loss calculating unit that calculates path loss on the basis of a reference signal received by the first reception processing unit; a transmit power setting unit that sets desired transmit power of an uplink signal using the path loss calculated by the path loss calculating unit; and a power head room control unit that generates power head room that is information concerning a margin of the transmit power using the desired transmit power set by the transmit power setting unit to control transmission of the power head room. The power head room control unit determines to transmit the power head room upon switching of a kind of the reference signal used in the calculation in the path loss calculating unit.

(5) A communication method of the present invention is used in a mobile station apparatus communicating with at least one base station apparatus. The communication method at least includes the steps of receiving a signal from the base station apparatus; calculating path loss on the basis of a reference signal that is received; setting desired transmit power of an uplink signal using the calculated path loss; and generating power head room that is information concerning a margin of the transmit power using the desired transmit power that is set to control transmission of the power head room. It is determined to transmit the power head room upon switching of a kind of the reference signal used in the calculation.

(6) An integrated circuit of the present invention is mounted in a mobile station apparatus communicating with at least one base station apparatus and causes the mobile station apparatus to carry out a plurality of functions. The integrated circuit at least includes the functions of receiving a signal from the base station apparatus; calculating path loss on the basis of a reference signal that is received; setting desired transmit power of an uplink signal using the calculated path loss; generating power head room that is information concerning a margin of the transmit power using the desired transmit power that is set to control transmission of the power head room; and determining to transmit the power head room upon switching of a kind of the reference signal used in the calculation.

Although the present invention is disclosed in terms of improvement of the mobile station apparatus, the communication system, the communication method, and the integrated circuit in a case in which information about the transmit power of the mobile station apparatus is indicated to the base station apparatus in the present description, the communication method to which the present invention is applicable is not limited to the LTE or a communication method, such as the LTE-A, having upward compatibility with the LTE. For example, the present invention is also applicable to Universal Mobile Telecommunications System (UMTS).

### Advantageous Effects of Invention

According to the present invention, it is possible for the base station apparatus to efficiently control the transmission of the uplink signal to the mobile station apparatus.

### BRIEF DESCRIPTION OF DRAWINGS

FIG. 1 is a block diagram schematically illustrating the configuration of a base station apparatus 3 according to an embodiment of the present invention.

FIG. 2 is a block diagram schematically illustrating the configuration of a transmission processing unit 107 in the base station apparatus 3 according to the embodiment of the present invention.

FIG. 3 is a block diagram schematically illustrating the configuration of a reception processing unit 101 in the base station apparatus 3 according to the embodiment of the present invention.

FIG. 4 is a block diagram schematically illustrating the configuration of a mobile station apparatus 5 according to an embodiment of the present invention.

FIG. 5 is a block diagram schematically illustrating the configuration of a reception processing unit 401 in the mobile station apparatus 5 according to the embodiment of the present invention.

FIG. 6 is a block diagram schematically illustrating the configuration of a transmission processing unit 407 in the mobile station apparatus 5 according to the embodiment of the present invention.

FIG. 7 is a flowchart illustrating an example of a process of transmitting power head room in the mobile station apparatus 5 according to an embodiment of the present invention.

FIG. 8 is a diagram for schematically describing the entire configuration of a communication system according to an embodiment of the present invention.

FIG. 9 is a diagram schematically illustrating the structure of time frames on a downlink from the base station apparatus 3 to the mobile station apparatus 5 according to the embodiment of the present invention.

FIG. 10 is a diagram illustrating an example of how downlink reference signals (CRSs and UE specific RSs) are arranged in a downlink subframe in the communication system 1 according to the embodiment of the present invention.

FIG. 11 is a diagram illustrating an example of how downlink reference signals (CSI-RSs) are arranged in the downlink subframe in the communication system 1 according to the embodiment of the present invention.

FIG. 12 is a diagram schematically illustrating the structure of time frames on an uplink from the mobile station apparatus 5 to the base station apparatus 3 according to the embodiment of the present invention.

### DESCRIPTION OF EMBODIMENTS

The technology described in the present description may be used in various radio communication systems including a Code Division Multiple Access (CDMA) system, a Time Division Multiple Access (TDMA) system, a Frequency Division Multiple Access (FDMA) system, an orthogonal FDMA (OFDMA) system, a single-carrier FDMA (SC-FDMA) system, and other systems. The terms “system” and “network” may be frequently synonymously used. The CDMA system may implement a radio technology (standard), such as Universal Terrestrial Radio Access (UTRA) or cdma2000 (registered trademark). The UTRA includes Wideband CDMA (WCDMA) and other improvements of the CDMA. The cdma2000 covers Interim Standard-2000 (IS-2000), IS-95, and IS-856. The TDMA system may implement a radio technology, such as Global System for Mobile Communications (GSM) (registered trademark). The OFDMA system may implement a radio technology, such as Evolved UTRA (E-UTRA), Ultra Mobile Broadband (UMB), Institute of Electrical and Electronic Engineers (IEEE) 802.11 (Wireless Fidelity (Wi-Fi)), IEEE 802.16 (Worldwide Interoperability for Microwave Access (WiMAX)), IEEE 802.20, or Flash-OFDM (registered trademark). The UTRA and the E-UTRA are part of Universal Mobile Telecommunications System (UMTS). 3GPP Long Term Evolution (3GPP LTE) is the UMTS using the E-UTRA that adopts the OFDMA on the downlink and the SC-FDMA on the uplink. The LTE-A is a system, a radio technology, and a standard resulting from improvement of the LTE. The UTRA, the E-UTRA, the UMTS, the LTE, the LTE-A, and the GSM (registered trademark) are described in documents published from an organization named 3rd Generation Partnership Project (3GPP). The cdma2000 and the UMB are described in documents published from an organization named 3rd Generation Partnership Project 2 (3GPP2). Some aspects of the present technology are described below in terms of data communication in the LTE and the LTE-A for clarity, and LTE terms and LTE-A terms are frequently used in the following description.

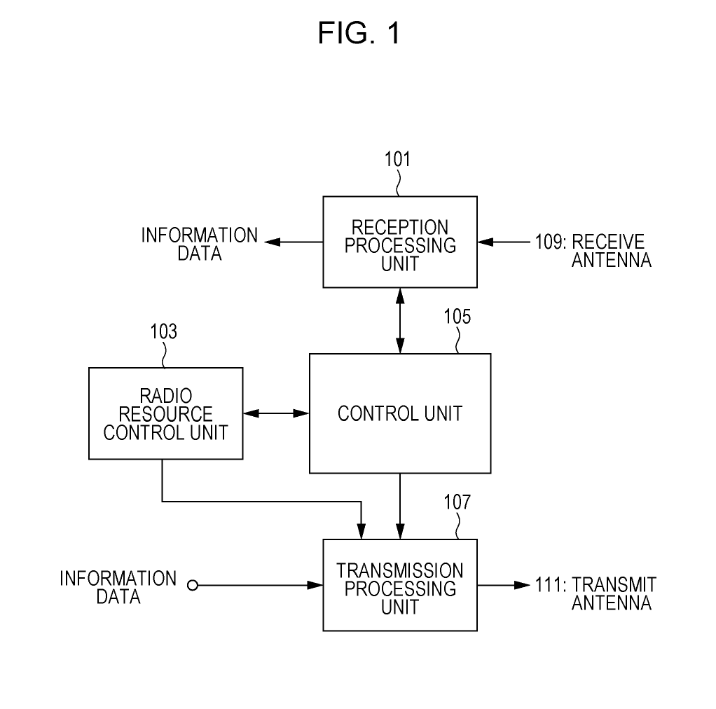

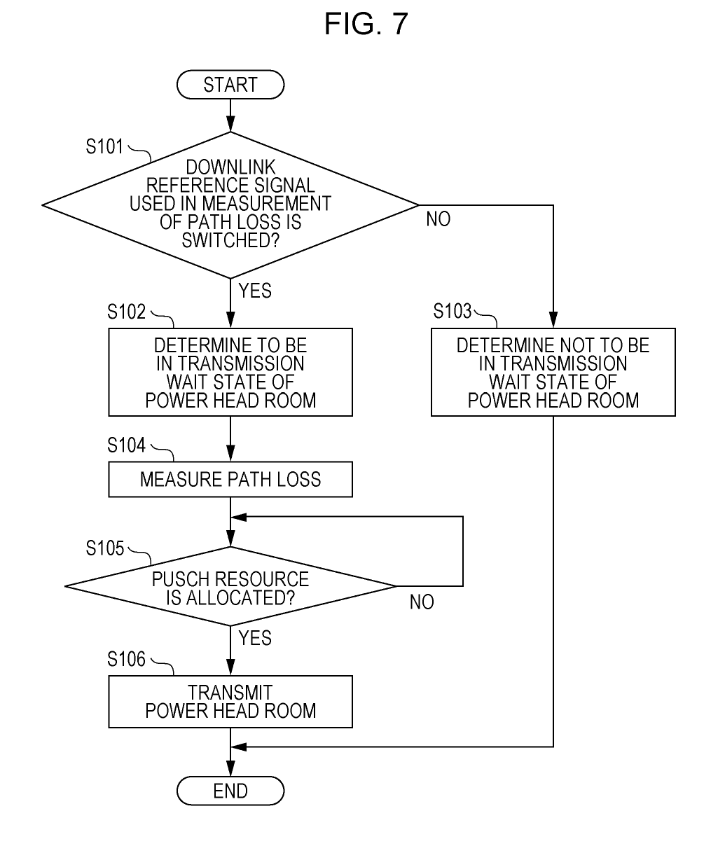

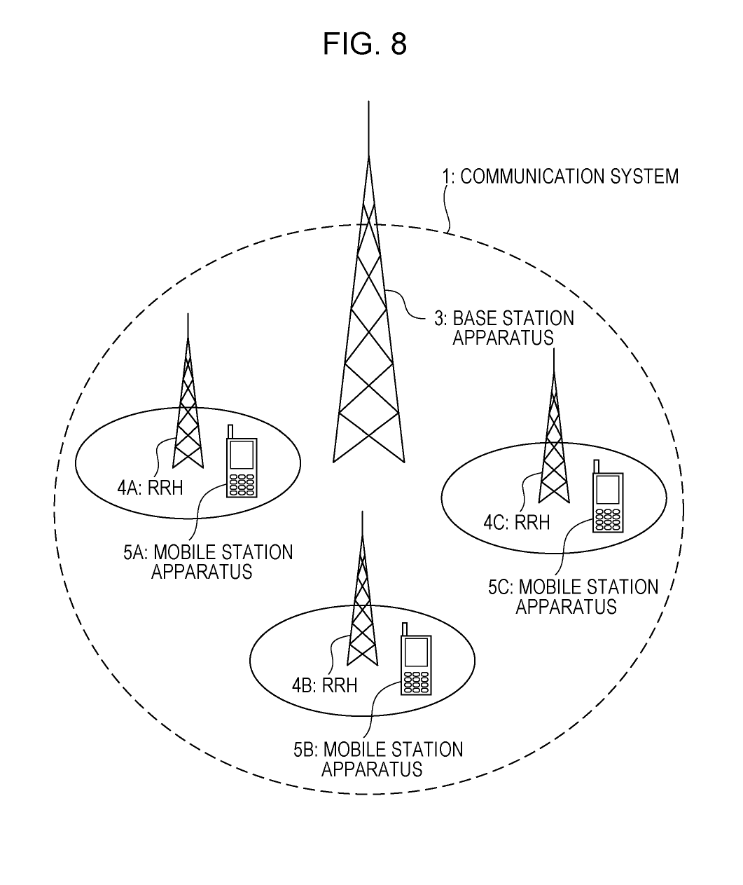

Embodiments of the present invention will herein be described in detail with reference to the attached drawings. First, the entire configuration of a communication system according to an embodiment, the structure of radio frames, and so on will be described with reference to FIG. 8 to FIG. 12. Next, the configuration of the communication system according to the embodiment will be described with reference to FIG. 1 to FIG. 6. Next, an operational process of the communication system according to the embodiment will be described with reference to FIG. 7.

### <Entire Configuration of Communication System>

FIG. 8 is a diagram for schematically describing the entire configuration of the communication system according to the embodiment of the present invention. In a communication system 1 illustrated in FIG. 8, a base station apparatus (also referred to as an eNodeB, a NodeB, a base station (BS), an access point (AP), or a macro base station) 3, multiple remote radio heads (RRHs: apparatuses including outdoor radio units smaller than the base station apparatus, also referred to as remote radio units (RRUs)) (also referred to as remote antennas or distributed antennas) 4A, 4B, and 4C, and multiple mobile station apparatuses (also referred to as user equipment (UE), mobile stations (MSs), mobile terminals (MTs), terminals, terminal apparatuses, or mobile terminals) 5A, 5B, and 5C communicate with each other. The RRHs 4A, 4B, and 4C are referred to as an RRH 4 and the mobile station apparatuses 5A, 5B, and 5C are referred to as a mobile station apparatus 5 for appropriate description in the embodiments. In the communication system 1, the base station apparatus 3 and the RRH 4 cooperatively communicate with the mobile station apparatus 5. The base station apparatus 3 and the RRH 4A perform the cooperative multipoint communication with the mobile station apparatus 5A, the base station apparatus 3 and the RRH 4B perform the cooperative multipoint communication with the mobile station apparatus 5B, and the base station apparatus 3 and the RRH 4C perform the cooperative multipoint communication with the mobile station apparatus 5C in FIG. 8. In addition, in the communication system 1, the multiple RRHs 4 cooperatively communicate with the mobile station apparatus 5. For example, the RRH 4A and the RRH 4B perform the cooperative multipoint communication with the mobile station apparatus 5A or the mobile station apparatus 5B, the RRH 4B and the RRH 4C perform the cooperative multipoint communication with the mobile station apparatus 5B or the mobile station apparatus 5C, and the RRH 4C and the RRH 4A perform the cooperative multipoint communication with the mobile station apparatus 5C or the mobile station apparatus 5A.

The RRH may be said to be a special form of the base station apparatus. For example, the RRH may be said to be the base station apparatus which includes only a signal processor and in which parameters used in the RRH by another base station apparatus are set and scheduling is determined. Accordingly, it should be noted that the representation of the base station apparatus 3 appropriately includes the RRH 4 in the following description.

### <Cooperative Multipoint Communication>

In the communication system 1 according to the embodiment of the present invention, the cooperative multipoint communication (CoMP communication) in which multiple cells are used to cooperatively transmit and receive signals may be used. For example, a communication mode of the base station apparatus using one arbitrary frequency band is referred to as a “cell.” For example, different weights are applied to signals in weighted signal processing (precoding processing) in multiple cells (the base station apparatus 3 and the RRH 4) and the base station apparatus 3 and the RRH 4 cooperatively transmit the signals to the same mobile station apparatus 5 as the cooperative multipoint communication. For example, multiple cells (the base station apparatus 3 and the RRH 4) cooperatively perform the scheduling of the mobile station apparatus 5 (coordinated scheduling (CS)) as the cooperative multipoint communication. For example, multiple cells (the base station apparatus 3 and the RRH 4) cooperatively apply the beamforming to transmit signals to the mobile station apparatus 5 (coordinated beamforming (CB)) as the cooperative multipoint communication. For example, only one cell (the base station apparatus 3 or the RRH 4) transmits a signal using a certain resource and the other cell (the base station apparatus 3 or the RRH 4) does not transmit a signal using the certain resource (blanking or muting) as the cooperative multipoint communication.

As for the multiple cells used in the cooperative multipoint communication, different cells may be composed of different base station apparatuses 3, different cells may be composed of different RRHs 4 managed by the same base station apparatus 3, or different cells may be composed of the base station apparatus 3 and the RRHs managed by another base station apparatus 3 different from the base station apparatus 3, although a description of this is omitted in the embodiments of the present invention.

Although the multiple cells are physically used as different cells, the multiple cells may be logically used as the same cell. Specifically, a configuration in which a common cell identifier (a physical cell identifier (ID)) is used for each cell may be adopted. A configuration in which multiple transmission apparatuses (the base station apparatus 3 and the RRH 4) use the same frequency to transmit common signals to the same reception apparatus is referred to as a single frequency network (SFN).

The communication system 1 of the embodiment of the present invention is supposed to be developed as the heterogeneous network development. The communication system 1 is composed of the base station apparatus 3 and the RRH 4 and has a configuration in which the coverage supported by the base station apparatus 3 includes part of the coverage or the entire coverage supported by the RRH 4. The coverage means an area in which the communication is capable of being realized while meeting a request. In the communication system 1, the base station apparatus 3 and the RRH 4 cooperatively transmit signals to the mobile station apparatus 5 the coverage of which is overlapped with the coverages of the base station apparatus 3 and the RRH 4. The RRH 4 is managed by the base station apparatus 3 and the transmission and reception to and from the RRH 4 is controlled by the base station apparatus 3. The base station apparatus 3 and the RRH 4 are connected to each other via a wired line, such as optical fiber, or a radio network using a relay technology.

The mobile station apparatus 5 may use the single-cell communication with the base station apparatus 3 or the RRH 4 if the mobile station apparatus 5 is positioned near the base station apparatus 3 or the RRH 4. In other words, a certain mobile station apparatus 5 communicates with the base station apparatus 3 or the RRH 4 without using the cooperative multipoint communication to transmit and receive signals to and from the base station apparatus 3 or the RRH 4. For example, the base station apparatus 3 may receive an uplink signal from the mobile station apparatus 5 close to the base station apparatus 3. For example, the RRH 4 may receive an uplink signal from the mobile station apparatus 5 close to the RRH 4. In addition, for example, both the base station apparatus 3 and the RRH 4 may receive an uplink signal from the mobile station apparatus 5 positioned near the edge (at the cell edge) of the coverage built by the RRH 4. In addition, for example, the multiple RRHs 4 may receive an uplink signal from the mobile station apparatus 5 positioned near the edge (at the cell edge) of the coverage built by each RRH 4.

The mobile station apparatus 5 may receive signals transmitted from both the base station apparatus 3 and the RRH 4 using the cooperative multipoint communication on the downlink and may transmit a signal to either of the base station apparatus 3 and the RRH 4 in an appropriate form on the uplink. For example, the mobile station apparatus 5 transmits the uplink signal with transmit power appropriate for the reception of the signal by the base station apparatus 3. For example, the mobile station apparatus 5 transmits the uplink signal with transmit power appropriate for the reception of the signal by the RRH 4.

The frequency band used in the base station apparatus 3 may be different from the frequency band used in the RRH 4 and the cooperative multipoint communication may be used only between different RRHs 4. For example, the mobile station apparatus 5 transmits the uplink signal with transmit power appropriate for the reception of the signal by each RRH 4.

In the communication system 1, the downlink (DL), which is a communication direction from the base station apparatus 3 or the RRH 4 to the mobile station apparatus 5, includes a downlink pilot channel, a physical downlink control channel (PDCCH), and a physical downlink shared channel (PDSCH). The cooperative multipoint communication may be applied or may not be applied to the PDSCH.

In the communication system 1, the uplink (UL), which is a communication direction from the mobile station apparatus 5 to the base station apparatus 3 or the RRH 4, includes a physical uplink shared channel (PUSCH), an uplink pilot channel (an uplink reference signal (UL RS), a sounding reference signal (SRS), a demodulation reference signal (DM RS)), and a physical uplink control channel (PUCCH). The channel means a medium used for transmission of signals. The channel used in a physical layer is referred to as a physical channel and the channel used in a medium access control (MAC) layer is referred to as a logical channel.

The present invention is applicable to a communication system in which the mobile station apparatus 5 is caused to transmit a signal with transmit power appropriate for the reception by the base station apparatus 3 and to transmit a signal with transmit power appropriate for the reception by the RRH 4 on the uplink. Although a description of other operations is appropriately omitted for simplicity, it should be noted that the present invention is not limited to such operations. For example, the present invention is also applicable to a communication system in which the mobile station apparatus 5 is caused to transmit a signal with transmit power optimal for the reception by the RRH 4 and to transmit a signal with transmit power semi-optimal for the reception by the base station apparatus 3 on the uplink.

The embodiments of the present invention are not limited to the communication system 1 in which only the channels described in the description are used and are also applicable to a communication system in which other channels are used. For example, a downlink control channel (Enhanced PDCCH (E-PDCCH)) having a property different from that of the PDCCH may be used independently of the PDCCH. For example, the precoding processing may be applied to the E-PDCCH. For example, the E-PDCCH may be subjected to a demodulation process, such as channel compensation, based on the reference signal to which processing similar to the precoding processing used on the E-PDCCH is applied.

The PDSCH is the physical channel used for transmission and reception of downlink data and control information. The PDCCH is the physical channel used for transmission and reception of downlink control information. The PUSCH is the physical channel used for transmission and reception of uplink data and control information. The PDCCH is the physical channel used for transmission and reception of uplink control information (UCI). A reception confirmation response (ACK/NACK) indicating acknowledgement (ACK) or negative acknowledgement (NACK) for the downlink data on the PDSCH, a scheduling request (SR) indicating whether allocation of a resource is requested, and so on are used as kinds of the UCI. A synchronization channel (SCH) (a synchronization signal) used for establishment of downlink synchronization, a physical random access channel (PRACH) used for establishment of uplink synchronization, a physical broadcast channel (PBCH) used for transmission of downlink system information (also referred to as a system information block (SIB)), and so on are used as other kinds of the physical channels. The PDSCH is also used for transmission of the downlink system information.

The mobile station apparatus 5, the base station apparatus 3, or the RRH 4 arranges a signal generated from the control information, the data, or the like on each physical channel to transmit the signal. The data transmitted on the PDSCH or the PUSCH is referred to as a transport block. An area managed by the base station apparatus 3 or the RRH 4 is referred to as a cell.

### <Structure of Time Frame on Downlink>

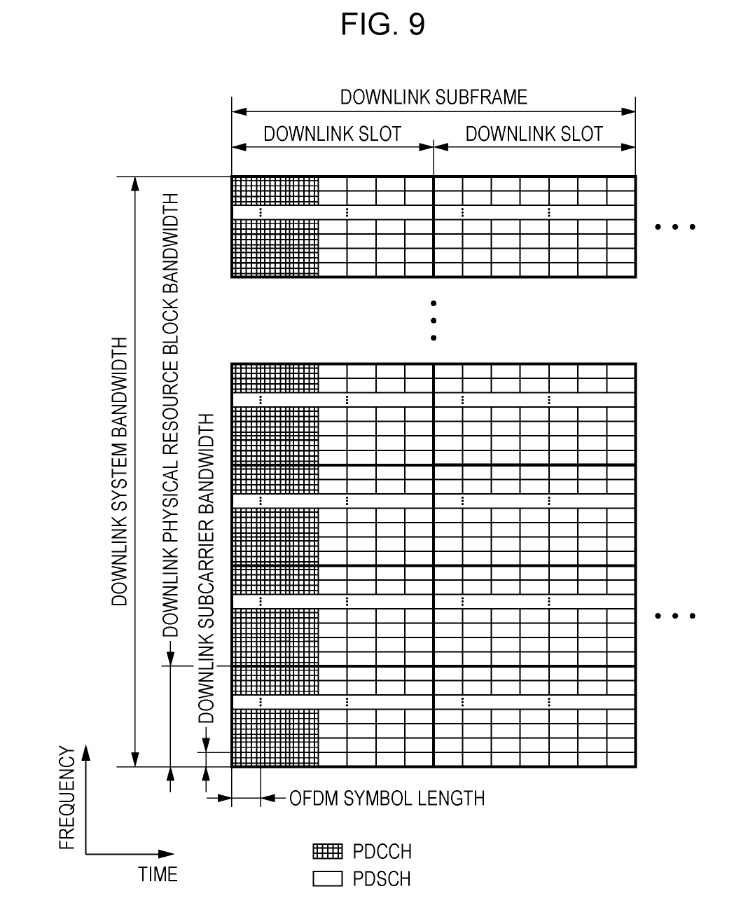

FIG. 9 is a diagram schematically illustrating the structure of time frames on the downlink from the base station apparatus 3 or the RRH 4 to the mobile station apparatus 5 according to the embodiment of the present invention. The horizontal axis represents time domain and the vertical axis represents frequency domain in FIG. 9. The time frame on the downlink is a unit of, for example, allocation of resources and is composed of a pair (referred to as a physical resource block pair (PRB pair) of resource blocks (RBs) (also referred to as physical resource blocks (PRBs)) having a frequency band of a certain width on the downlink and a time zone of a certain width on the downlink. One downlink PRB pair (referred to as one physical resource block pair (one DL PRB pair)) is composed of two contiguous PRBs in the time domain on the downlink (referred to as downlink physical resource blocks (DL PRBs).

In FIG. 9, one DL PRB is composed of 12 subcarriers (referred to as downlink subcarriers) in the frequency domain on the downlink and is composed of seven Orthogonal Frequency Division Multiplexing (OFDM) symbols in the time domain on the downlink. A system band on the downlink (referred to as a downlink system band) is a communication band on the downlink of the base station apparatus 3 or the RRH 4. For example, a system bandwidth on the downlink (referred to as a downlink system bandwidth) is composed of a 20-MHz frequency bandwidth.

In the downlink system band, multiple DL PRBs are arranged depending on the downlink system bandwidth. For example, the downlink system band of the 20-MHz frequency bandwidth is composed on 110 DL PRBs.

Slots (referred to as downlink slots) each composed of seven OFDM symbols and a subframe (referred to as a downlink subframe) composed of two downlink slots exist in the time domain illustrated in FIG. 9. A unit composed of one downlink subcarrier and one OFDM symbol is referred to as a resource element (RE) (a downlink resource element). At least the PDSCH used for transmission of information data (also referred to as the transport block) and the PDCCH used for transmission of the control information are arranged in each downlink subframe. In FIG. 9, the PDCCH is composed of first to third OFDM symbols in the downlink subframe and the PDSCH is composed of fourth to fourteenth OFDM symbols in the downlink subframe. The number of the OFDM symbols composing the PDCCH and the number of the OFDM symbols composing the PDSCH may be varied for each downlink subframe.

The downlink pilot channels used for transmission of the reference signal (RS) on the downlink (referred to as a downlink reference signal) are dispersed in multiple downlink resource elements, although not illustrated in FIG. 9. The downlink reference signal is composed of at least a first reference signal, a second reference signal, and a third reference signal of different types. For example, the downlink reference signal is used for estimation of channel variation on the PDSCH and the PDCCH. For example, the first reference signal is used for demodulation on the PDSCH and the PDCCH and is also referred to as a Cell specific RS (CRS). For example, the second reference signal is used for demodulation on the PDSCH to which the cooperative multipoint communication is applied and is also referred to as an UE specific RS. For example, the third reference signal is used only for estimation of the channel variation and is also referred to as a Channel State Information RS (CSI-RS). The downlink reference signal is a known signal in the communication system 1. The number of the downlink resource elements composing the downlink reference signal may depend on the number of transmit antennas (antenna ports) used in the communication with the mobile station apparatus 5 in the base station apparatus 3 or the RRH 4. A case in which the CRS is used as the first reference signal, the UE specific RS is used as the second reference signal, and the CSI-RS is used as the third reference signal will be described below. The UE specific RS is also used for demodulation on the PDSCH to which the cooperative multipoint communication is not applied.

Signals generated from the control information, such as information indicating allocation of the DL PRBs on the PDSCH, information indicating allocation of UL PRBs on the PUSCH, and/or information indicating a mobile station identifier (referred to as a radio network temporary identifier (RNTI)), a modulation method, a coding rate, a retransmission parameter, a spatial multiplexing number, a precoding matrix, and a transmit power control command (TPC command), are arranged on the PDCCH. The control information included on the PDCCH is referred to as downlink control information (DCI). The DCI including the information indicating allocation of the DL PRBs on the PDSCH is referred to as downlink assignment (DL assignment) (also referred to as downlink grant) and the DCI including the information indicating allocation of the UL PRBs on the PUSCH is referred to as uplink grant (UL grant). The downlink assignment includes the transmit power control command for the PUCCH. Uplink assignment includes the transmit power control command for the PUSCH. One PDCCH only includes information indicating allocation of one PDSCH resource or information indicating allocation of one PUSCH resource and does not include information indicating allocation of multiple PDSCH resources and information indicating allocation of multiple PUSCH resources.

In addition, the information transmitted on the PDCCH includes a cyclic redundancy check (CRC) code. The relationship between the DCI, the RNTI, and the CRC transmitted on the PDCCH will now be described in detail. The CRC code is generated from the DCI by using a predetermined generator polynomial. Exclusive OR (also referred to as scrambling) processing is performed by using the RNTI for the generated CRC code. A signal resulting from modulation of a bit indicating the DCI and a bit generated from the exclusive OR processing for the CRC code by using the RNTI (referred to as a CRC masked by UE ID) is practically transmitted on the PDCCH.

The PDSCH resource is arranged on the same downlink subframe as the downlink subframe in which the PDCCH resource including the downlink assignment used for the allocation of the PDSCH resource is arranged in the time domain.

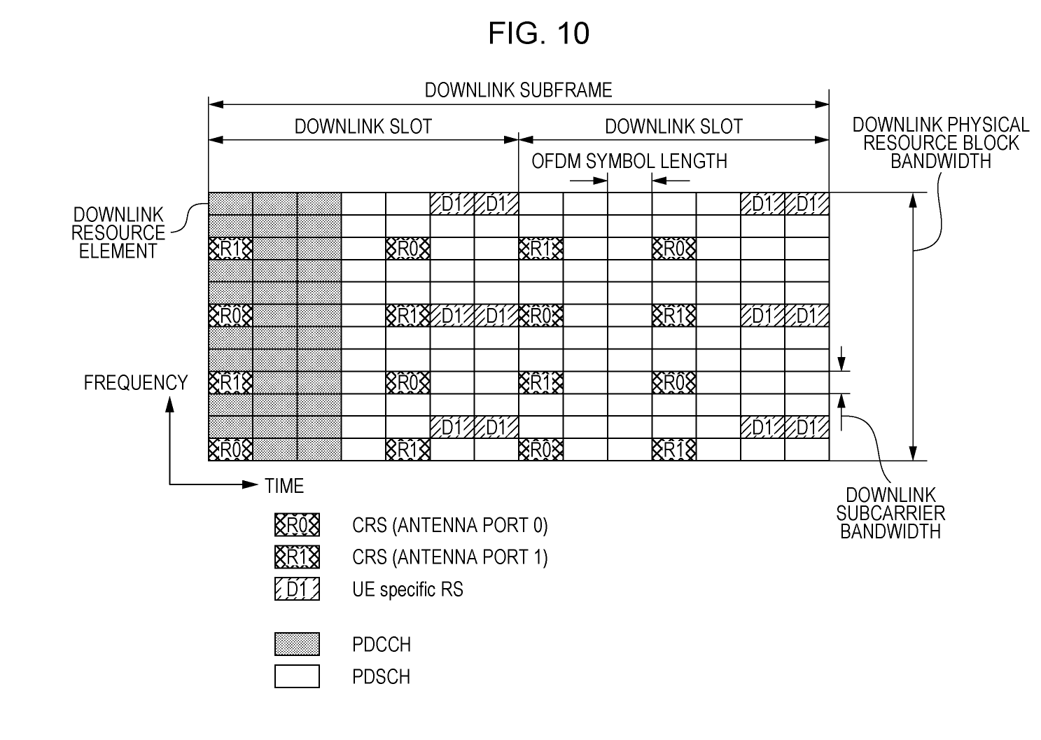

How the downlink reference signals are arranged will now be described. FIG. 10 is a diagram illustrating an example of how the downlink reference signals are arranged in the downlink subframe in the communication system 1 according to the embodiment of the present invention. Although the arrangement of the downlink reference signals in one PRB pair is described with reference to FIG. 10 for simplicity, a common arrangement method is basically used for all the PRB pairs within the downlink system band.

Among the downlink resource elements that are hatched, R0 to R1 denotes the CRSs at antenna ports 0 to 1, respectively. The antenna port means a logical antenna used in the signal processing and one antenna port may be composed of multiple physical antennas. The same signal is transmitted through the multiple physical antennas composing the same antenna port. Although delay diversity or cyclic delay diversity (CDD) may be applied by using the multiple physical antennas at the same antenna port, it is not possible to use other signal processing. Although a case in which the CRS corresponds to two antenna ports is illustrated in FIG. 10, the communication system of the present embodiment may correspond to the antenna ports of a number other than two. For example, the CRS for one antenna port or four antenna ports may be mapped in a downlink resource. The CRSs are arranged in all the DL PRBs in the downlink system band.

Among the downlink resource elements marked with diagonal lines, D1 indicates the UE specific RS. When multiple antenna ports are used to transmit the UE specific RS, different codes are used in different antenna ports. In other words, Code Division Multiplexing (CDM) is applied to the UE specific RS. In the UE specific RS, the length of the code used in the CDM and/or the number of the downlink resource elements that are mapped may be varied depending on the type of the signal processing (the number of the antenna ports) used for the control signal and the data signal to be mapped on the PRB pair. For example, when the number of the antenna ports used in the cooperative multipoint communication in the base station apparatus 3 or the RRH 4 is two, the UE specific RSs are multiplexed and arranged with the code the length of which is two by using the two downlink resource elements in the contiguous time domains (OFDM symbols) in the same frequency domain (subcarrier) as one unit (the unit of the CDM). In other words, in this case, the CDM is applied for the multiplexing of the UE specific RS. For example, when the number of the antenna ports used in the cooperative multipoint communication in the base station apparatus 3 or the RRH 4 is four, the number of the downlink resource elements on which the UE specific RSs are mapped is doubled and the UE specific RSs are multiplexed and arranged on different downlink resource elements for every two antenna ports. In other words, in this case, the CDM and Frequency Division Multiplexing (FDM) are applied for the multiplexing of the UE specific RS. For example, when the number of the antenna ports used in the cooperative multipoint communication in the base station apparatus 3 or the RRH 4 is eight, the number of the downlink resource elements on which the UE specific RSs are mapped is doubled and the UE specific RSs are multiplexed and arranged with the code the length of which is four by using the four downlink resource elements as one unit. In other words, in this case, the CDM of a different code length is applied for the multiplexing of the UE specific RS.

In the UE specific RS, a scramble code is further superimposed on the code of each antenna port. The scramble code is generated on the basis of a cell ID and a scramble ID indicated from the base station apparatus 3 or the RRH 4. For example, the scramble code is generated from a pseudo noise sequence that is generated on the basis of the cell ID and the scramble ID indicated from the base station apparatus 3 or the RRH 4. For example, the scramble ID is a value indicating zero or one. The scramble ID that is used and the antenna port may be subjected to joint coding to index information indicating the scramble ID and the antenna port. The UE specific RSs are arranged in the DL PRBs on the PDSCH allocated to the mobile station apparatus 5 for which the use of the UE specific RSs is set.

The base station apparatus 3 and the RRH 4 may allocate the CRS signals to different downlink resource elements or may allocate the CRS signals to the same downlink resource element. For example, when the base station apparatus 3 and the RRH 4 allocate the CRS signals to different resource elements and/or different signal sequences, the mobile station apparatus 5 is capable of using the CRSs to individually compute receive power (receive signal power or reception quality) of the respective resource elements or signal sequences. In particular, when the cell ID indicated from the base station apparatus 3 is different from the cell ID indicated from the RRH 4, the above setting is enabled. In another example, only the base station apparatus 3 allocates the CRS signals to some downlink resource elements and the RRH 4 allocates the CRS signal to no downlink resource element. In this case, the mobile station apparatus 5 is capable of computing the receive power of the base station apparatus 3 from the CRSs. In particular, when the cell ID is notified only from the base station apparatus 3, the above setting is enabled. In another example, when the base station apparatus 3 and the RRH 4 allocate the CRS signals to the same downlink resource element and the base station apparatus 3 and the RRH 4 transmit the same sequence, the mobile station apparatus 5 is capable of computing the receive power that is combined by using the CRSs. In particular, when the same cell ID is indicated from the base station apparatus 3 and the RRH 4, the above setting is enabled.

In the description of the embodiments of the present invention, for example, the computation of the power includes computation of the value of the power, the calculation of the power includes calculation of the value of the power, the measurement of the power includes measurement of the value of the power, and report of the power includes report of the value of the power. The representation “the power” appropriately also includes the meaning of the value of the power.

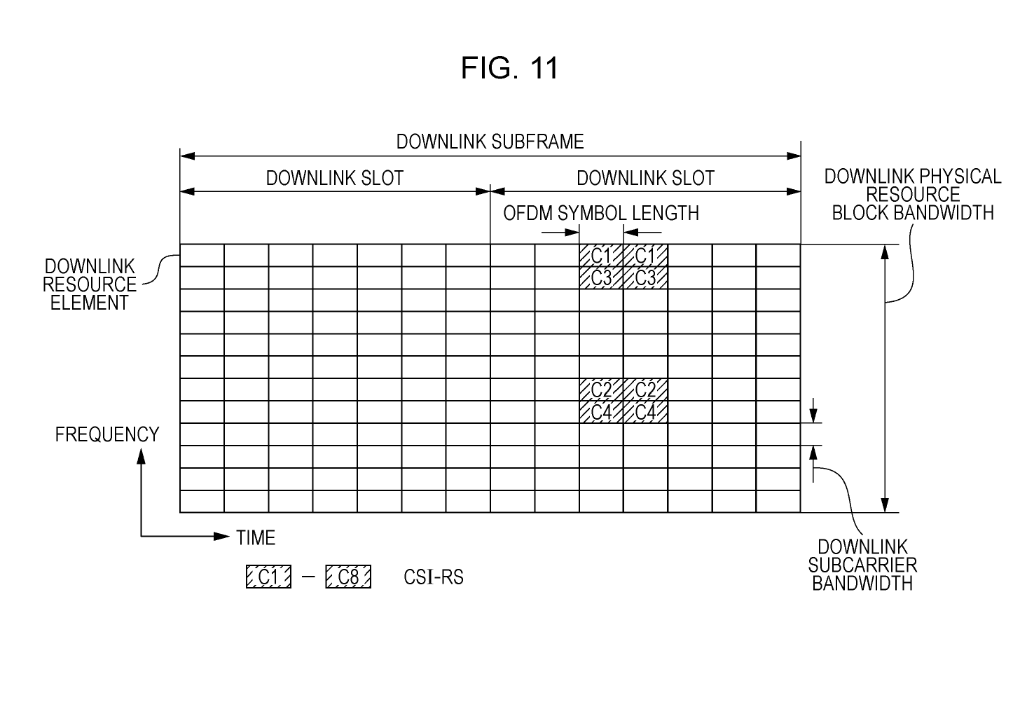

FIG. 11 is a diagram illustrating the DL PRB pair in which the CSI-RSs (channel-state information reference signals) for eight antenna ports are mapped. FIG. 11 illustrates how the CSI-RSs are mapped when the numbers of the antenna ports (the number of CSI ports) used in the base station apparatus 3 or the RRH 4 are eight. The CRS, the UE specific RS, the PDCCH, the PDSCH, and the likes are not illustrated in FIG. 11 for simplicity.

In the CSI-RS, an orthogonal code (Walsh code) of two chips is used in each CDM group, the CSI port (the port for the CSI-RS (the antenna port or a resource grid)) is allocated to each orthogonal code, and the code division multiplexing is performed for every two CSI ports. In addition, each CDM group is subjected to the frequency division multiplexing. Four CDM groups are used to map the CSI-RSs of the eight antenna ports: CSI ports 1 to 8 (antenna ports 15 to 22). For example, in a CSI-RS CDM group C1, the CSI-RSs of the CSI ports 1 and 2 (the antenna ports 15 and 16) are subjected to the code division multiplexing and the mapping. In a CSI-RS CDM group C2, the CSI-RSs of the CSI ports 3 and 4 (the antenna ports 17 and 18) are subjected to the code division multiplexing and the mapping. In a CSI-RS CDM group C3, the CSI-RSs of the CSI ports 5 and 6 (the antenna ports 19 and 20) are subjected to the code division multiplexing and the mapping. In a CSI-RS CDM group C4, the CSI-RSs of the CSI ports 7 and 8 (the antenna ports 21 and 22) are subjected to the code division multiplexing and the mapping.

When the number of the antenna ports in the base station apparatus 3 and the RRH 4 is eight, the base station apparatus 3 and the RRH 4 are capable of setting the number of layers (a rank or the spatial multiplexing number) applied to the PDSCH to up to eight. The base station apparatus 3 and the RRH 4 are capable of transmitting the CSI-RSs when the number of the antenna ports is one, two, or four. The base station apparatus 3 and the RRH 4 are capable of transmitting the CSI-RSs for one antenna port or two antenna ports by using the CSI-RS CDM group C1 illustrated in FIG. 11. The base station apparatus 3 and the RRH 4 are capable of transmitting the CSI-RSs for four antenna ports by using the CSI-RS CDM groups C1 and C2 illustrated in FIG. 11.

The downlink resource element to which the base station apparatus 3 allocates the CSI-RS signals may be different from the downlink resource element to which the RRH 4 allocates the CSI-RS signals or the downlink resource element to which the base station apparatus 3 allocates the CSI-RS signals may be the same as the downlink resource element to which the RRH 4 allocates the CSI-RS signals. For example, when the base station apparatus 3 and the RRH 4 allocate different downlink resource elements and/or different signal sequences to the CSI-RSs, the mobile station apparatus 5 is capable of using the CSI-RSs to individually compute the receive power (the receive signal power or the reception quality) and the channel state of each of the base station apparatus 3 and the RRH 4. In another example, when the base station apparatus and the RRH 4 allocate the same downlink resource element to the CSI-RSs and the base station apparatus 3 and the RRH 4 transmit the same sequence, the mobile station apparatus 5 is capable of using the CSI-RSs to compute the receive power that is combined. Different RRHs 4 may allocate the CSI-RS signals to different downlink resource elements. For example, when different RRHs 4 allocate different downlink resource elements and/or different signal sequences to the CSI-RSs, the mobile station apparatus 5 is capable of using the CSI-RSs to individually compute the receive power (the receive signal power or the reception quality) and the channel state of each of the RRHs 4.

The configuration of the CSI-RS (CSI-RS-Config-r10) is indicated from the base station apparatus 3 or the RRH 4 to the mobile station apparatus 5. The configuration of the CSI-RS at least includes information indicating the number of the antenna ports set for the CSI-RSs (antennaPortsCount-r10), information indicating the downlink subframe in which the CSI-RSs are arranged (subframeConfig-r10), and information indicating the frequency domain in which the CSI-RSs are arranged (resourceConfig-10). The number of the antenna ports is set to a value of one, two, four, or eight. An index indicating the position of the first resource element, among the resource elements in which the CSI-RS corresponding to the antenna port 15 (the CSI port 1) is arranged, is used as the information indicating the frequency domain in which the CSI-RSs are arranged. Upon determination of the position of the CSI-RS corresponding to the antenna port 15, the CSI-RSs corresponding to the other antenna ports are uniquely determined on the basis of a predetermined rule. The position and the cycle of the downlink subframe in which the CSI-RSs are arranged is indicated with the index as the information indicating the downlink subframe in which the CSI-RSs are arranged. For example, subframe Confing-r10 having an index of five indicates that the CSI-RSs are arranged for every ten subframes and indicates that the CSI-RS is arranged in the subframe 0 (the number of the subframe in the radio frame) in the radio frame in units of 10 subframes. In another example, subframeConfig-r10 having an index of one indicates that the CSI-RSs are arranged for every five subframes and indicates that the CSI-RSs are arranged in the subframes 1 and 6 in the radio frame in units of 10 subframes.

A case in which only the RRH 4 transmits the CSI-RS at least corresponding to a certain antenna port is mainly supposed in the embodiments of the present invention. This includes a case in which only the RRH 4 transmits the CSI-RSs corresponding to all the antenna ports for the CSI-RS. When only the RRH 4 transmits the CSI-RSs corresponding to part of the antenna ports, the CSI-RSs corresponding to the other antenna ports may be transmitted only from the base station apparatus 3 or may be transmitted from both the base station apparatus 3 and the RRH 4 (SFN transmission). The CRSs may be transmitted only from the base station apparatus 3 or may be transmitted from both the base station apparatus 3 and the RRH 4 (the SFN transmission).

The mobile station apparatus 5 receives the CSI-RS at the certain antenna port transmitted only from the RRH 4, measures the path loss of the RRH 4, and uses the path loss that is measured to set the transmit power of the uplink signal, although a detailed description of this is described below. This allows the transmit power appropriate for the case in which the destination of the signal is the RRH 4 to be set. The mobile station apparatus 5 may receive the RS (the CRS or the CSI-RS) transmitted only from the base station apparatus 3, may measure the path loss of the base station apparatus 3, and may use the path loss that is measured to set the transmit power of the uplink signal. This allows the transmit power appropriate for the case in which the destination of the signal is the base station apparatus 3 to be set. The mobile station apparatus 5 may receive the RSs (the CRSs or the CSI-RSs) transmitted from both the base station apparatus 3 and the RRH 4, may measure the path loss from a signal resulting from combination of both of the signals, and may use the path loss that is measured to set the transmit power of the uplink signal. This allows the transmit power appropriate to some extent for the case in which the destination of the signal is the base station apparatus 3 or the RRH 4 to be set. As described above, setting the transmit power appropriate for the destination of the signal allows the interference with other signals to be suppressed while meeting the signal quality that is required to improve the efficiency of the communication system. The communication system is mainly supposed in the embodiments of the present invention, in which the mobile station apparatus 5 measures multiple path losses from the downlink reference signals of different kinds and uses one of the path losses or each path loss to control the transmit power of the uplink signal, as described above.

The information about the antenna port for the CSI-RS transmitted only from the RRH 4 is indicated to the mobile station apparatus 5. The mobile station apparatus 5 is capable of measuring the path loss for the signal transmitted from the RRH 4 on the basis of the indicated information. A case in which the CRS is basically transmitted only from the base station apparatus 3 and the CSI-RS is basically transmitted only from the RRH 4 will be described in the following description for simplicity. Accordingly, it is indicated in the following description that the path loss measured on the basis of the CRS is for the signal transmitted from the base station apparatus 3 and that the path loss measured on the basis of the CSI-RS is for the signal transmitted from the RRH 4. The embodiments of the present invention are described for the communication system described above for simplicity and the following description is not intended to limit the present invention. The present invention is applicable to, for example, a communication system in which the CRSS are transmitted from both the base station apparatus 3 and the RRH 4 and a communication system in which only the CSI-RS at a certain antenna port is transmitted only from the RRH 4.

The information about the transmit power of the CRS and the transmit power of the CSI-RS are indicated from the base station apparatus 3 or the RRH 4 to the mobile station apparatus 5 by using RRC signaling. The mobile station apparatus 5 uses the transmit power of the downlink reference signal of each kind, which is indicated, to measure (calculate) the path loss from the downlink reference signal of each kind, although a detailed description of this is described below.

Different CSI-RS configurations may be applied to different RRHs 4. For example, the CSI-RSs may be arranged in different downlink subframes in different CSI-RS configurations of different RRHs 4. For example, the CSI-RSs may be arranged in different frequency domains in different CSI-RS configurations in different RRHs 4. For example, the number of the antenna ports for the CSI-RSs may be varied in different CSI-RS configurations in different RRHs 4. The information about the CSI-RS configurations for the respective RRHs 4, to which the cooperative multipoint communication is applied, is indicated from the base station apparatus 3 or the RRH 4 to the mobile station apparatus 5 by using the RRC signaling. The mobile station apparatus 5 receives the CSI-RS transmitted from each RRH 4 and measures the path loss of each RRH 4 on the basis of the CSI-RS configurations that are indicated to set the measured path loss for the transmit power of the uplink signal. Accordingly, the mobile station apparatus 5 is capable of setting the transmit power appropriate for each RRH 4, which is the destination of the signal. As described above, setting the transmit power appropriate for the destination of the signal allows the interference with other signals to be suppressed while meeting the signal quality that is required to improve the efficiency of the communication system. The present invention may be applied to the communication system in which the mobile station apparatus 5 measures multiple path losses from the downlink reference signals of different kinds and uses one of the path losses or each path loss to control the transmit power of the uplink signal, as described above. More specifically, the mobile station apparatus 5 may measure multiple path losses from the multiple CSI-RS having different CSI-RS configurations and may use one of the path losses or each path loss to control the transmit power of the uplink signal.

### <Structure of Time Frame on Uplink>

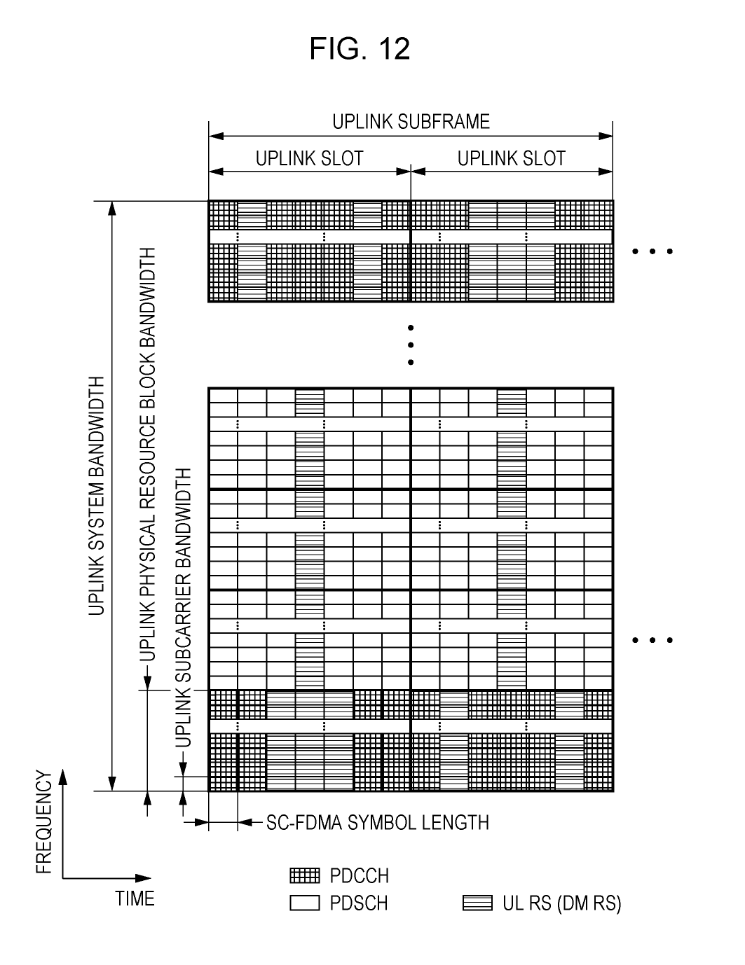

FIG. 12 is a diagram schematically illustrating the structure of time frames on the uplink from the mobile station apparatus 5 to the base station apparatus 3 or the RRH 4 according to the embodiment of the present invention. The horizontal axis represents time domain and the vertical axis represents frequency domain in FIG. 12. The time frame on the uplink is a unit of, for example, allocation of resources and is composed of a physical resource block pair (referred to as an uplink physical resource block pair (UL PRB pair) having a frequency band of a certain width on the uplink and a time zone of a certain width on the uplink. One UL PRB pair is composed of two contiguous uplink PRBs in the time domain on the uplink (referred to as uplink physical resource blocks (UL PRBs).

In FIG. 12, one UL PRB is composed of 12 subcarriers (referred to as uplink subcarriers) in the frequency domain on the uplink and is composed of seven Single-Carrier Frequency Division Multiple Access (SC-FDMA) symbols in the time domain. A system band on the uplink (referred to as an uplink system band) is a communication band on the uplink of the base station apparatus 3 or the RRH 4. A system bandwidth on the uplink (referred to as an uplink system bandwidth) is composed of a 20-MHz frequency bandwidth.

In the uplink system band, multiple UL PRBs are arranged depending on the uplink system bandwidth. For example, the uplink system band of the 20-MHz frequency bandwidth is composed on 110 UL PRBs. Slots (referred to as uplink slots) each composed of seven SC-FDMA symbols and a subframe (referred to as an uplink subframe) composed of two uplink slots exist in the time domain illustrated in FIG. 12. A unit composed of one uplink subcarrier and one SC-FDMA symbol is referred to as a resource element (an uplink resource element).

At least the PUSCH used for transmission of the information data, the PUCCH used for transmission of the uplink control information (UCI), and the UL RS (DM RS) for demodulation of the PUSCH and the PUCCH (estimation of the channel variation) are arranged in each uplink subframe. The PRACH used for establishment of the uplink synchronization is arranged in any uplink subframe, although not illustrated in FIG. 12. The UL RS (SRS) used for, for example, measurement of the channel quality and synchronization shift is arranged in any uplink subframe, although not illustrated in FIG. 12. The PUCCH is used to transmit the UCI (ACK/NACK) indicating the acknowledgement (ACK) or the negative acknowledgement (NACK) for the data received on the PDSCH, the UCI (the scheduling request (SR)) at least indicating whether allocation of an uplink resource is requested, and the UCI (the channel quality indicator (CQI)) indicating the uplink reception quality (also referred to as the channel quality).

When the mobile station apparatus 5 indicates to the base station apparatus 3 that the mobile station apparatus 5 requests allocation of an uplink resource, the mobile station apparatus 5 transmits the signal on the PUCCH for transmission of the SR. The base station apparatus 3 recognizes that the mobile station apparatus 5 requests allocation of an uplink resource from a result of detection of the signal on the PUCCH resource for transmission of the SR. When the mobile station apparatus 5 indicates to the base station apparatus 3 that the mobile station apparatus 5 does not request allocation of an uplink resource, the mobile station apparatus 5 transmits no signal on the PUCCH resource for transmission of the SR, which is allocated in advance. The base station apparatus 3 recognizes that the mobile station apparatus 5 does not request allocation of an uplink resource from a result of detection of no signal on the PUCCH resource for transmission of the SR.

The PUCCH uses different kinds of signal structures in the case in which the UCI composed of the ACK/NACK is transmitted, the case in which the UCI composed of the SR is transmitted, and the case in which the UCI composed of the CQI is transmitted. The PUCCH used for transmission of the ACK/NACK is referred to as PUCCH format 1a or PUCCH format 1b. In the PUCCH format 1a, Binary Phase Shift Keying (BPSK) is used as the modulation method for modulating information about the ACK/NACK. One-bit information is indicated from the modulation signal in the PUCCH format 1a. In the PUCCH format 1b, Quadrature Phase Shift Keying (QPSK) is used as the modulation method for modulating information about the ACK/NACK. Two-bit information is indicated from the modulation signal in the PUCCH format 1b. The PUCCH used for transmission of the SR is referred to as PUCCH format 1. The PUCCH used for transmission of the CQI is referred to as PUCCH format 2. The PUCCH used for simultaneous transmission of the CQI and the ACK/NACK is referred to as PUCCH format 2a or PUCCH format 2b. In the PUCCH format 2b, the reference signal (DM RS) on the uplink pilot channel is multiplied by the modulation signal generated from the information about the ACK/NACK. In the PUCCH format 2a, the one-bit information about the ACK/NACK and the information about the CQI are transmitted. In the PUCCH format 2b, the two-bit information about the ACK/NACK and the information about the CQI are transmitted.

One PUSCH is composed of one or more UL PRBs. One PUCCH is composed of two UL PRBs that are symmetric to each other in the frequency domain in the uplink system band and that are positioned at different uplink slots. One PRACH is composed of six UL PRB pairs. For example, in the uplink subframe in FIG. 12, the UL PRB having the lowest frequency in the first uplink slot and the UL PRB having the highest frequency in the second uplink slot compose one UL PRB pair used for the PUCCH. If the PUCCH resource and the PUSCH resource are allocated in the same uplink subframe when the mobile station apparatus 5 is set so as not to perform the simultaneous transmission of the PUSCH and the PUCCH, the mobile station apparatus 5 transmits the signal using only the PUSCH resource. If the PUCCH resource and the PUSCH resource are allocated in the same uplink subframe when the mobile station apparatus 5 is set so as to perform the simultaneous transmission of the PUSCH and the PUCCH, the mobile station apparatus 5 is basically capable of transmitting the signal using both the PUCCH resource and the PUSCH resource.

The UL RS is used for the uplink pilot channel. The UL RS is composed of the demodulation reference signal (DM RS) used for the estimation of the channel variation on the PUSCH and the PUCCH and the sounding reference signal (SRS) used in the measurement of the channel quality for frequency scheduling and adoptive modulation on the PUSCH in the base station apparatus 3 or the RRH 4 and the measurement of the synchronization shift between the base station apparatus 3 or the RRH 4 and the mobile station apparatus 5. The SC-FDMA symbol at which the DM RS is arranged when the DM RS is arranged in the same UL PRB as that on the PUSCH is different from the SC-FDMA symbol at which the DM RS is arranged when the DM RS is arranged in the same UL PRB as that on the PUCCH. The DM RS is a known signal in the communication system 1, which is used for the estimation of the channel variation on the PUSCH and the PUCCH.

The DM RS is arranged at the fourth SC-FDMA symbol in the uplink slot when the DM RS is arranged in the same UL PRB as that on the PUSCH. The DM RSs are arranged at the third, fourth, and fifth SC-FDMA symbols in the uplink slot when the DM RSs are arranged in the same UL PRB as that on the PUCCH including the ACK/NACK. The DM RSs are arranged at the third, fourth, and fifth SC-FDMA symbols in the uplink slot when the DM RSs are arranged in the same UL PRB as that on the PUCCH including the SR. The DM RSs are arranged at the second and sixth SC-FDMA symbols in the uplink slot when the DM RSs are arranged in the same UL PRB as that on the PUCCH including the CQI.

The SRS is arranged in the UL PRB determined by the base station apparatus 3 and is arranged at the fourteenth SC-FDMA symbol in the uplink subframe (the seventh SC-FDMA symbol in the second uplink slot in the uplink subframe). The SRS may be arranged only in the uplink subframes on a cycle determined by the base station apparatus 3 in the cell (referred to as a sounding reference signal subframe (SRS subframe). The base station apparatus 3 allocates the cycle on which the SRS is transmitted and the UL PRB to be allocated to the SRS to the SRS subframe for every mobile station apparatus 5.

Although the case in which the PUCCH is arranged at the UL PRB at the end of the frequency domain in the uplink system band is illustrated in FIG. 12, for example, the second or third UL PRB from the end of the uplink system band may be used for the PUCCH.

The code multiplexing in the frequency domain and the code multiplexing in the time domain are used on the PUCCH. In the code multiplexing in the frequency domain, the modulation signal resulting from modulation of the uplink control information is multiplied by each code in a code sequence for each subcarrier. In the code multiplexing in the time domain, the modulation signal resulting from modulation of the uplink control information is multiplied by each code in the code sequence for each SC-FDMA symbol. The multiple PDCCHs are arranged in the same UL PRB and different codes are allocated to the respective PUCCHs to realize the code multiplexing in the frequency domain or the time domain with the allocated codes. In the PUCCH used for transmission of the ACK/NACK (referred to as the PUCCH format 1a or the PUCCH format 1b), the code multiplexing in the frequency domain and the code multiplexing in the time domain are used. In the PUCCH used for transmission of the SR (referred to as the PUCCH format 1), the code multiplexing in the frequency domain and the code multiplexing in the time domain are used. In the PUCCH used for transmission of the CQI (referred to as the PUCCH format 2, the PUCCH format 2a, or the PUCCH format 2b), the code multiplexing in the frequency domain is used. A description of the content concerning the code multiplexing on the PUCCH is appropriately omitted for simplicity.

The PUSCH resource is arranged in the uplink subframe a certain number (for example, four) after the downlink subframe in which the PDCCH resource including the uplink grant used for the allocation of the PUSCH resource is arranged in the time domain.

### <Switching Between Path Loss Based on CRS and Path Loss Based on CSI-RS>

The mobile station apparatus 5 calculates (measures) the path loss on the basis of the CRS or the CSI-RS, calculates the uplink transmit power on the basis of the calculated path loss, and transmits the uplink signal with the uplink transmit power of the calculated value. The base station apparatus 3 sets parameters (configuration) concerning the measurement of the downlink reference signal for the mobile station apparatus 5. In the initial state (default state), the mobile station apparatus 5 calculates the path loss on the basis of the CRS and calculates the uplink transmit power value using the calculated path loss. The mobile station apparatus 5 calculates the path loss on the basis of the CRS at the antenna port 0 or the CRSs at the antenna ports 0 and 1 in the initial state.

If the base station apparatus 3 determines that the need arises (for example, determines that the mobile station apparatus 5 is close to the RRH 4), the base station apparatus 3 makes the setting for the mobile station apparatus 5 so as to calculate the path loss on the basis of the CSI-RS and use the path loss for the uplink transmit power. Specifically, the base station apparatus 3 changes (resets or reconfigures) path loss reference in the mobile station apparatus 5. For example, the change is performed by using the RRC signaling. The path loss reference means a measurement target used for the calculation of the path loss and is the CRS or the CSI-RS. The base station apparatus 3 may specify the antenna port of the CSI-RS which the mobile station apparatus 5 uses for the calculation of the path loss, and the mobile station apparatus 5 calculates the path loss on the basis of the CSI-RS at the antenna port specified by the base station apparatus 3. The antenna port specified for the mobile station apparatus 5 by the base station apparatus 3 may be one antenna port, may be multiple antenna ports, or may be all the antenna ports. In addition, if the base station apparatus 3 determines that the need arises, the base station apparatus 3 makes the setting for the mobile station apparatus 5 so as to calculate the path loss on the basis of the CRS and use the path loss for the uplink transmit power. This operation may be performed in the state in which the mobile station apparatus 5 calculates the path loss on the basis of the CSI-RS.

Since the transmit power value for the downlink reference signal is required for the calculation of the path loss, the information about the transmit power value for the CRS and the information about the transmit power value for the CSI-RS are indicated from the base station apparatus 3 to the mobile station apparatus 5.

### <Switching Between Path Losses Based on CSI-RSs of Different CSI-RS Configurations>

The mobile station apparatus 5 calculates (measures) the path loss on the basis of any of the CSI-RSs of multiple CSI-RS configurations (a first CSI-RS configuration and a second CSI-RS configuration), calculates the uplink transmit power on the basis of the calculated path loss, and transmits the uplink signal with the uplink transmit power of the calculated value. The base station apparatus 3 sets the parameters (configuration) concerning the measurement of the downlink reference signal for the mobile station apparatus 5.

If the base station apparatus 3 determines that the need arises (for example, determines that the mobile station apparatus 5 is close to a certain RRH 4), the base station apparatus 3 makes the setting for the mobile station apparatus 5 so as to calculate the path loss on the basis of the CSI-RSs of different CSI-RS configurations and use the path loss for the uplink transmit power. Specifically, the base station apparatus 3 changes (resets or reconfigures) the path loss reference in the mobile station apparatus 5. For example, the change is performed by using the RRC signaling. The path loss reference means a measurement target used for the calculation of the path loss and is the CSI-RS of the first CSI-RS configuration or the CSI-RS of the second CSI-RS configuration. The antenna port for the CSI-RS used for the calculation of the path loss may be fixedly selected by the mobile station apparatus 5 or whether the CSI-RSs for multiple antenna ports are used may be selected by the mobile station apparatus 5. If the base station apparatus 3 determines that the need arises, the base station apparatus 3 makes the setting for the mobile station apparatus 5 so as to calculate the path loss on the basis of the CSI-RS of the second CSI-RS configuration and use the path loss for the uplink transmit power. This operation may be performed in the state in which the mobile station apparatus 5 calculates the path loss on the basis of the CSI-RS of the first CSI-RS configuration. In addition, if the base station apparatus 3 determines that the need arises, the base station apparatus 3 makes the setting for the mobile station apparatus 5 so as to calculate the path loss on the basis of the CSI-RS of the first CSI-RS configuration and use the path loss for the uplink transmit power. This operation may be performed in the state in which the mobile station apparatus 5 calculates the path loss on the basis of the CSI-RS of the second CSI-RS configuration.

Since the transmit power value for the downlink reference signal is required for the calculation of the path loss, the information about the transmit power values for the CSI-RSs of the respective CSI-RS configurations is indicated from the base station apparatus 3 to the mobile station apparatus 5.

If the frequency band of the cell of the base station apparatus 3 is different from the frequency band of the cell of the RRH 4, the CRS may not be configured in the cell of the RRH 4 and only the CSI-RS may be configured therein. For example, in this case, the mobile station apparatus 5 may set a process in which the path loss is calculated on the basis of the CSI-RS for the cell of the RRH 4 to calculate the uplink transmit power value using the calculated path loss to the initial state (the default state), instead of setting a process in which the path loss is calculated on the basis of the CRS for the cell of the RRH 4 to calculate the uplink transmit power value using the calculated path loss to the initial state (the default state). If the base station apparatus 3 determines that addition of the RRH 4 used for the cooperative multipoint communication is required for the mobile station apparatus 5, the base station apparatus 3 indicates the configuration of the CSI-RS for the cell of the RRH 4 to the mobile station apparatus 5 to additionally change (reset or reconfigure) the path loss reference of the mobile station apparatus 5.

### <Power Head Room Reporting>

The power head room reporting is a process for providing information (the power head room) concerning the difference between a nominal UE maximum transmit power and an estimated transmit power for the PUSCH to the base station apparatus 3 or the RRH 4. The power head room reporting is controlled by the radio resource control (RRC), which is a processing hierarchy, the two timers (the periodicPHR-Timer timer and the prohibitPHR-Timer timer) are configured for the control, and one parameter (the dl-PathlossChange) is subjected to the signaling.

The dl-PathlossChange is a parameter to trigger the transmission of the power head room when the value of the path loss is varied. The amount of variation between the path loss measured when the power head room was transmitted last time and the path loss that is currently measured is used for threshold value determination with the dl-PathlossChange parameter. The threshold value determination using the dl-PathlossChange parameter is performed and, if the amount of variation that is measured exceeds the value of the dl-PathlossChange parameter, the transmission of the power head room is triggered. The value of the dl-PathlossChange parameter is represented in decibel (dB) units and, for example, any of values: one dB, three dB, six dB, and infinity is used.

The periodicPHR-Timer is a timer used to substantially periodically trigger the transmission of the power head room. When the periodicPHR-Timer timer is terminated, the transmission of the power head room is triggered. Upon transmission of the power head room, the periodicPHR-Timer timer that is being measured is temporarily reset and is restarted. The value of the periodicPHR-Timer timer is represented in units of the number of subframes and, for example, any of values: 10 subframes, 20 subframes, 50 subframes, 100 subframes, 200 subframes, 500 subframes, 1,000 subframes, and infinity is used.

The prohibitPHR-Timer is a timer used to prevent the transmission of the power head room from being triggered frequently more than necessary. While the prohibitPHR-Timer timer is not terminated and is being measured, the transmission of the power head room is not triggered even if the amount of variation of the path loss that is measured exceeds the value of the dl-PathlossChange parameter. When the prohibitPHR-Timer timer is terminated, the transmission of the power head room may be triggered with the dl-PathlossChange parameter. Upon transmission of the power head room, the prohibitPHR-Timer timer that is being measured is temporarily reset and is restarted. The value of the prohibitPHR-Timer timer is represented in units of the number of subframes and, for example, any of values: 0 subframes, 10 subframes, 20 subframes, 50 subframes, 100 subframes, 200 subframes, 500 subframes, and 1,000 subframes is used.

The periodicPHR-Timer timer, the prohibitPHR-Timer timer, and the dl-PathlossChange parameter are indicated from the base station apparatus 3 or the RRH 4 to the mobile station apparatus 5 by using a structure of the RRC signaling, phr-Config. Upon initial setting of phr-Config (configuration of power head room reporting functionality) or resetting of phr-Config (reconfiguration of the power head room reporting functionality), the transmission of the power head room is triggered.

The value of the power head room indicates the difference between the transmit power value that is configured in the mobile station apparatus 5 in advance and a desired PUSCH transmit power value. The desired PUSCH transmit power value is calculated with the parameter used in the transmit power control by using a predetermined equation (algorithm). For example, the desired PUSCH transmit power value is set for meeting the quality that is required. A smaller value, among the transmit power value that is configured in the mobile station apparatus 5 in advance and the desired PUSCH transmit power value, is used as the value of the PUSCH transmit power that is practically transmitted. The transmit power value that is configured in the mobile station apparatus 5 in advance is the transmit power value that is set for the mobile station apparatus 5 by the base station apparatus 3 or the RRH 4 in advance or the upper limit of an allowable transmit power, which is the apparatus capacity of the mobile station apparatus 5. For example, the apparatus capacity corresponds to the class of a power amplifier. The value of the power head room is represented in units of one decibel within a range from 40 dB to −23 dB.

The mobile station apparatus 5 enters a transmission wait state of the power head room when the downlink reference signal used in the measurement (calculation or estimation) of the path loss is switched (set, configured, changed, reset, reconfigured, or rechanged) by the base station apparatus 3 or the RRH 4. The transmission wait state is also said to be a state in which the transmission of the power head room is triggered. Upon allocation of the PUSCH resource for new transmission excluding retransmission by the base station apparatus 3 or the RRH 4, the mobile station apparatus 5 in the transmission wait state transmits a signal including the information about the power head room using the PUSCH to which the resource is allocated. The calculation of the value of the power head room is basically based on the transmit power value set on the PUSCH used for the transmission of the power head room. Precisely, the desired PUSCH transmit power value described above is used for the calculation of the power head room. If the desired PUSCH transmit power value described above is lower than the transmit power value that is configured in the mobile station apparatus 5 in advance, the PUSCH transmit power value used for the transmission of the power head room is the desired PUSCH transmit power value. If the desired PUSCH transmit power value described above is higher than the transmit power value that is configured in the mobile station apparatus 5 in advance, the PUSCH transmit power value used for the transmission of the power head room is the transmit power value that is configured in the mobile station apparatus 5 in advance. The target to be used in the measurement of the path loss is referred to as the path loss reference. The path loss used for the calculation of the uplink transmit power value is calculated from the path loss reference that is set. In other words, the calculation of the power head room is based on the path loss calculated from the path loss reference that is set.

For example, the mobile station apparatus 5 enters the transmission wait state when the state in which the path loss is measured on the basis of the CRS is switched to the state in which the path loss is measured on the basis of the CSI-RS. Here, the mobile station apparatus 5 enters the transmission wait state of the power head room based on the path loss measured from the CSI-RS. For example, the mobile station apparatus 5 enters the transmission wait state when the state in which the path loss is measured on the basis of the CSI-RS is switched to the state in which the path loss is measured on the basis of the CRS. Here, the mobile station apparatus 5 enters the transmission wait state of the power head room based on the path loss measured from the CRS. For example, the mobile station apparatus 5 enters the transmission wait state of the power head room when the state in which the path loss is measured on the basis of the CSI-RS of the first CSI-RS configuration is switched to the state in which the path loss is measured on the basis of the CSI-RS of the second CSI-RS configuration. Here, the mobile station apparatus 5 enters the transmission wait state of the power head room based on the path loss measured from the CSI-RS of the second CSI-RS configuration.

In the communication system in which the path loss reference is additionally set in the mobile station apparatus 5, the mobile station apparatus 5 may enter the transmission wait state of the power head room if the path loss reference is additionally set. The additional setting of the path loss reference means additional setting of the target (the downlink reference signal) used for the measurement of the path loss. For example, the mobile station apparatus 5 simultaneously performs the process of measuring the path loss on the basis of the CRS and the process of measuring the path loss on the basis of the CSI-RS in parallel. For example, the mobile station apparatus 5 simultaneously performs the process of measuring the path loss on the basis of the CSI-RS of the first CSI-RS configuration and the process of measuring the path loss on the basis of the CSI-RS of the second CSI-RS configuration in parallel. When the path loss reference is additionally set, the mobile station apparatus 5 enters the transmission wait state of the power head room based on the path loss measured from the added path loss reference.

For example, the mobile station apparatus 5 enters the transmission wait state of the power head room when, in a state in which only the process of measuring the path loss on the basis of the CRS is performed, the process of measuring the path loss on the basis of the CSI-RS is additionally set. Here, the mobile station apparatus 5 enters the transmission wait state of the power head room based on the path loss measured from the CSI-RS. For example, the mobile station apparatus 5 enters the transmission wait state of the power head room when, in a state in which only the process of measuring the path loss on the basis of the CSI-RS is performed, the process of measuring the path loss on the basis of the CRS is additionally set. Here, the mobile station apparatus 5 enters the transmission wait state of the power head room based on the path loss measured from the CRS.

For example, the mobile station apparatus 5 enters the transmission wait state of the power head room when, in a state in which the path loss is measured on the basis of the CSI-RS of a certain CSI-RS configuration, a process of measuring the path loss on the basis of the CSI-RS of another CSI-RS configuration is additionally set. Here, the mobile station apparatus 5 enters the transmission wait state of the power head room at least based on the path loss measured from the CSI-RS of the CSI-RS configuration that is added. In addition, the mobile station apparatus 5 may enter the transmission wait state of the power head room based on the path loss measured from the CSI-RS of the CSI-RS configuration that is originally set.

In the mobile station apparatus 5 in which multiple different path loss references are simultaneously set, the path losses of different kinds may be measured, the values of the measured path losses may be held, and the path loss used on the PUSCH may be switched for each uplink subframe. For example, which path loss reference on which the path loss is based is used for the PUSCH is indicated by the information on the PDCCH. For example, which path loss reference on which the path loss is based is used for the PUSCH is specified on the basis of the channel (the PDCCH or the E-PDCCH) used for the transmission of the uplink grant. For example, which path loss reference on which the path loss is based is used for the PUSCH in which uplink subframe is specified in advance. For example, which path loss reference on which the path loss is based is used for the PUSCH is specified on the basis of the downlink subframe in which the PDCCH including the uplink grant is arranged. Here, the relationship between the numbers of the downlink subframes and the corresponding kinds of the path loss references is set in advance.

Upon allocation of the PUSCH resource for new transmission using the path loss based on the path loss reference corresponding to the power head room in the transmission wait state, the mobile station apparatus 5 in the transmission wait state of the power head room transmits a signal including the information about the power head room in the transmission wait state using the PUSCH to which the resource is allocated. Upon allocation of the PUSCH resource for new transmission using the path loss based on the path loss reference that does not correspond to the power head room in the transmission wait state, the mobile station apparatus 5 does not perform the process of transmitting the power head room in the transmission wait state.

Multiple parameters concerning the power head room reporting may be set in the mobile station apparatus 5 in which multiple different path loss references are simultaneously set. For example, one periodicPHR-Timer timer, one prohibitPHR-Timer timer, and one dl-PathlossChange parameter may be set for each of the multiple path loss references. For example, multiple periodicPHR-Timer timers may be set. For example, multiple prohibitPHR-Timer timers may be set. For example, multiple dl-PathlossChange parameters may be set. The mobile station apparatus 5 may independently perform the power head room reporting processes for the power head rooms based on the path losses measured from different path loss references. The power head room reporting process is independently performed for each path loss reference. For example, when multiple periodicPHR-Timer timers are set, the determination of whether the periodicPHR-Timer timers are reset and restarted is based on whether the power head rooms calculated from the path loss references corresponding to the periodicPHR-Timer timers are transmitted. For example, when multiple periodicPHR-Timer timers are set, the power head rooms the transmission of which is triggered upon termination of the periodicPHR-Timer timers are calculated from the path loss references corresponding to the periodicPHR-Timer timers. For example, when multiple prohibitPHR-Timer timers are set, the determination of whether the prohibitPHR-Timer timers are reset and restarted is based on whether the power head rooms calculated from the path loss references corresponding to the prohibitPHR-Timer timers are transmitted. For example, when multiple prohibitPHR-Timer timers are set, the power head rooms the transmission of which is prohibited while the prohibitPHR-Timer timers are operating are calculated from the path loss references corresponding to the prohibitPHR-Timer timers. For example, when multiple dl-PathlossChange parameters are set, the threshold value determination with the amounts of variation between the dl-PathlossChange parameters and the path losses is performed for the path losses measured from the path loss references corresponding to the dl-PathlossChange parameters.

For example, a case in which the CRS and the CSI-RS are simultaneously set as the path loss references will now be described. The periodicPHR-Timer timer corresponding to the CRS is set as periodicPHR-Timer 1 and the periodicPHR-Timer timer corresponding to the CSI-RS is set as periodicPHR-Timer 3. The prohibitPHR-Timer timer corresponding to the CRS is set as prohibitPHR-Timer 1 and the prohibitPHR-Timer timer corresponding to the CSI-RS is set as prohibitPHR-Timer 3. The dl-PathlossChange parameter corresponding to the CRS is set as dl-PathlossChange 1 and the dl-PathlossChange parameter corresponding to the CSI-RS is set as dl-PathlossChange 3. When the power head room based on the CRS is transmitted, the periodicPHR-Timer 1, the prohibitPHR-Timer 1, and the dl-PathlossChange 1 that are being measured are reset (restarted). When the power head room based on the CSI-RS is transmitted, the periodicPHR-Timer 3, the prohibitPHR-Timer 3, and the dl-PathlossChange 3 that are being measured are reset (restarted). Upon termination of the periodicPHR-Timer 1, the power head room based on the CRS enters the transmission wait state. Upon termination of the periodicPHR-Timer 3, the power head room based on the CSI-RS enters the transmission wait state. While the prohibitPHR-Timer 1 is being measured (before the timer is terminated), a state in which the transmission of the power head room based on the CRS is prohibited arises. While the prohibitPHR-Timer 3 is being measured, a state in which the transmission of the power head room based on the CSI-RS is prohibited arises. The dl-PathlossChange 1 is used for the threshold value determination with the amount of variation of the path loss measured from the CRS. If the amount of variation of the path loss measured from the CRS is higher than the value of the dl-PathlossChange 1, the power head room based on the CRS enters the transmission wait state. The dl-PathlossChange 3 is used for the threshold value determination with the amount of variation of the path loss measured from the CSI-RS. If the amount of variation of the path loss measured from the CSI-RS is higher than the value of the dl-PathlossChange 3, the power head room based on the CSI-RS enters the transmission wait state.

For example, a case in which the CSI-RSs of multiple CSI-RS configurations (the first CSI-RS configuration and the second CSI-RS configuration) are simultaneously set as the path loss references will now be described. The periodicPHR-Timer timer corresponding to the CSI-RS of the first CSI-RS configuration is set as periodicPHR-Timer 1 and the periodicPHR-Timer timer corresponding to the CSI-RS of the second CSI-RS configuration is set as periodicPHR-Timer 3. The prohibitPHR-Timer timer corresponding to the CSI-RS of the first CSI-RS configuration is set as prohibitPHR-Timer 1 and the prohibitPHR-Timer timer corresponding to the CSI-RS of the second CSI-RS configuration is set as prohibitPHR-Timer 3. The dl-PathlossChange parameter corresponding to the CSI-RS of the first CSI-RS configuration is set as dl-PathlossChange 1 and the dl-PathlossChange parameter corresponding to the CSI-RS of the second CSI-RS configuration is set as dl-PathlossChange 3. When the power head room based on the CSI-RS of the first CSI-RS configuration is transmitted, the periodicPHR-Timer 1, the prohibitPHR-Timer 1, and the dl-PathlossChange 1 that are being measured are reset (restarted). When the power head room based on the CSI-RS of the second CSI-RS configuration is transmitted, the periodicPHR-Timer 3, the prohibitPHR-Timer 3, and the dl-PathlossChange 3 that are being measured are reset (restarted). Upon termination of the periodicPHR-Timer 1, the power head room based on the CSI-RS of the first CSI-RS configuration enters the transmission wait state. Upon termination of the periodicPHR-Timer 3, the power head room based on the CSI-RS of the second CSI-RS configuration enters the transmission wait state. While the prohibitPHR-Timer 1 is being measured (before the timer is terminated), a state in which the transmission of the power head room based on the CSI-RS of the first CSI-RS configuration is prohibited arises. While the prohibitPHR-Timer 3 is being measured, a state in which the transmission of the power head room based on the CSI-RS of the second CSI-RS configuration is prohibited arises. The dl-PathlossChange 1 is used for the threshold value determination with the amount of variation of the path loss measured from the CSI-RS of the first CSI-RS configuration. If the amount of variation of the path loss measured from the CSI-RS of the first CSI-RS configuration is higher than the value of the dl-PathlossChange 1, the power head room based on the CSI-RS of the first CSI-RS configuration enters the transmission wait state. The dl-PathlossChange 3 is used for the threshold value determination with the amount of variation of the path loss measured from the CSI-RS of the second CSI-RS configuration. If the amount of variation of the path loss measured from the CSI-RS of the second CSI-RS configuration is higher than the value of the dl-PathlossChange 3, the power head room based on the CSI-RS of the second CSI-RS configuration enters the transmission wait state.

### <Entire Configuration of Base Station Apparatus 3>

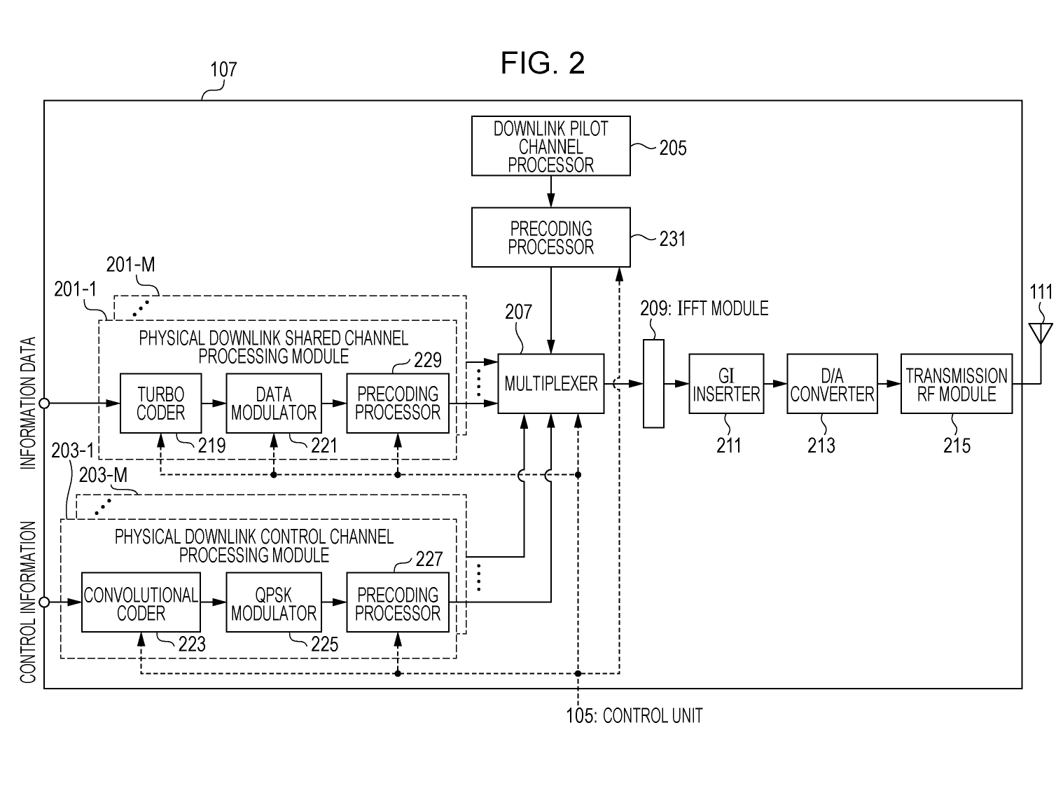

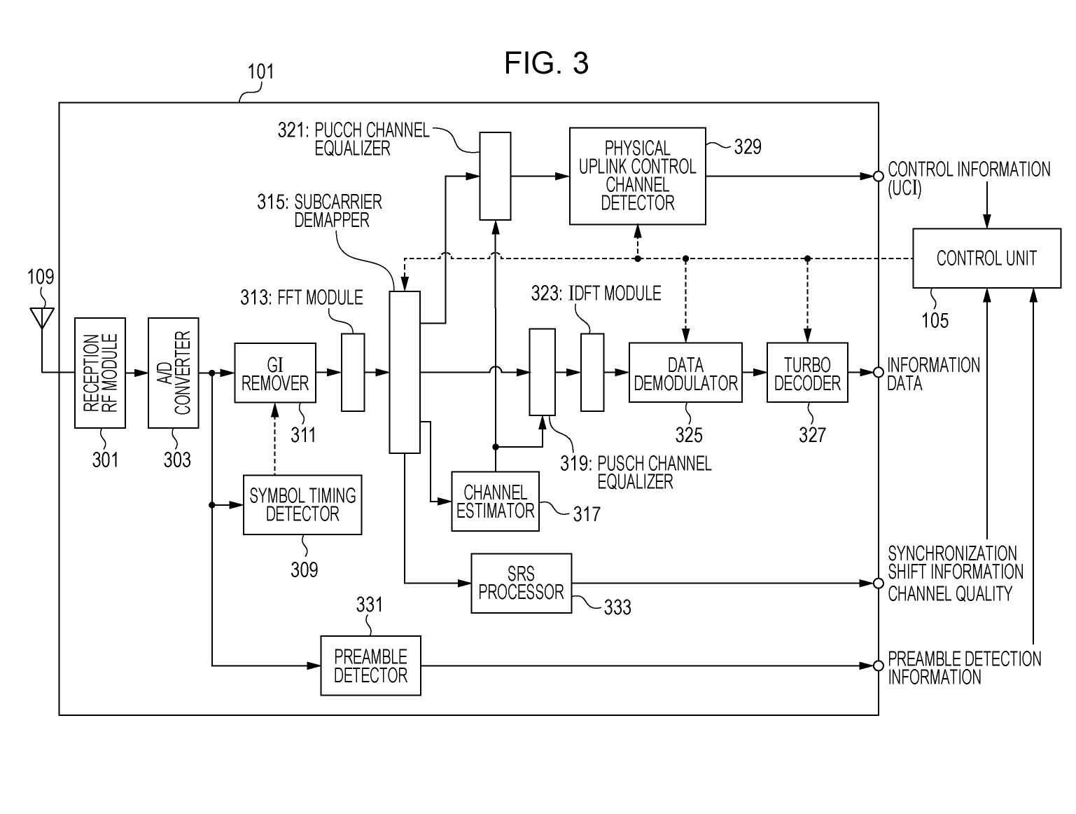

The configuration of the base station apparatus 3 according to an embodiment will now be described with reference to FIG. 1, FIG. 2, and FIG. 3. FIG. 1 is a block diagram schematically illustrating the configuration of the base station apparatus 3 according to the embodiment of the present invention. Referring to FIG. 1, the base station apparatus 3 includes a reception processing unit (a second reception processing unit) 101, a radio resource control unit (a second radio resource control unit) 103, a control unit (a second control unit) 105, and a transmission processing unit (a second transmission processing unit) 107.

The reception processing unit 101 modulates and decodes a PUCCH receive signal or a PUSCH receive signal received from the mobile station apparatus 5 through a receive antenna 109 using the UL RS in accordance with an instruction from the control unit 105 to extract the control information and/or the information data. For example, the reception processing unit 101 extracts the information about the power head room from the PUSCH. The reception processing unit 101 performs a process of extracting the UCI for the uplink subframe or the UL PRB in which the base station apparatus 3 allocates a PUCCH resource to the mobile station apparatus 5. The reception processing unit 101 is instructed by the control unit 105 which processing is to be performed to which uplink subframe or which UL PRB. For example, the reception processing unit 101 is instructed by the control unit 105 to perform a detection process in which multiplication and combination of the code sequences in the time domain and multiplication and combination of the code sequences in the frequency domain are performed to the PUCCH (the PUCCH format 1a or the PUCCH format 1b) signal for the ACK/NACK. In addition, the reception processing unit 101 is instructed by the control unit 105 of the code sequence in the frequency domain and/or the code sequence in the time domain, used in the process of detecting the UCI from the PUCCH. The reception processing unit 101 supplies the extracted UCI to the control unit 105 and supplies the information data to a higher layer. The reception processing unit 101 supplies the extracted UCI to the control unit 105 and supplies the information data to a higher layer.

Furthermore, the reception processing unit 101 detects (receives) a preamble sequence from a PRACH receive signal received from the mobile station apparatus 5 through the receive antenna 109 in accordance with an instruction from the control unit 105. The reception processing unit 101 estimates incoming timing (reception timing), along with the detection of the preamble sequence. The reception processing unit 101 performs the process of detecting the preamble sequence for the uplink subframe and the UL PRB to which the base station apparatus 3 allocates a PRACH resource. The reception processing unit 101 supplies information about the estimated incoming timing to the control unit 105.

Furthermore, the reception processing unit 101 measures the channel quality of one or more UL PRBs using the SRS received from the mobile station apparatus 5. The reception processing unit 101 detects (calculates or measures) the synchronization shift on the uplink using the SRS received from the mobile station apparatus 5. The reception processing unit 101 is instructed by the control unit 105 which processing is to be performed to which uplink subframe or which UL PRB. The reception processing unit 101 supplies information about the measured channel quality and the detected synchronization shift on the uplink to the control unit 105. The reception processing unit 101 will be described in detail below.

The radio resource control unit 103 performs setting of the configuration of the CSI-RS, allocation of a resource on the PDCCH, allocation of a resource on the PUCCH, allocation of a DL PRB on the PDSCH, allocation of a UL PRB on the PUSCH, allocation of a resource on the PRACH, allocation of a resource to the SRS, and setting of the modulation methods of various channels, the coding rate of various channels, the transmit power control value of various channels, the amount of phase rotation (the weight value) of various channels used in the precoding processing, and so on. The radio resource control unit 103 sets the parameters (the periodicPHR-Timer, the prohibitPHR-Timer, and the dl-PathlossChange) concerning the power head room reporting. The radio resource control unit 103 sets the downlink reference signal (the CRS or the CSI-RS) used in the measurement of the path loss for the mobile station apparatus 5. The radio resource control unit 103 also sets, for example, the code sequence in the frequency domain and the code sequence in the time domain for the PUCCH. The radio resource control unit 103 supplies, for example, the information indicating the allocation of the PUCCH resource, which is set, to the control unit 105. Part of the information set by the radio resource control unit 103 is indicated to the mobile station apparatus 5 through the transmission processing unit 107. For example, the information about the configuration of the CSI-RS, the information indicating the values of the parameters concerning the power head room reporting, the information indicating the values of part of the parameters concerning the PUSCH transmit power, and the information indicating the values of part of the parameters concerning the PUCCH transmit power are indicated to the mobile station apparatus 5.

In addition, the radio resource control unit 103 sets, for example, the allocation of the PDSCH radio resource on the basis of the UCI that is acquired by using the PUCCH in the reception processing unit 101 and that is supplied through control unit 105. For example, when the ACK/NACK acquired from the PUCCH is supplied, the radio resource control unit 103 performs the allocation of the PDSCH resource indicating the NACK in the ACK/NACK for the mobile station apparatus 5.

The radio resource control unit 103 supplies various control signals to the control unit 105. For example, the control signals include the control signal indicating the allocation of the PUSCH resource and the control signal indicating the amount of phase rotation used in the precoding processing.

The control unit 105 controls setting of the CSI-RS, allocation of a DL PRB on the PDSCH, allocation of a resource on the PDCCH, setting of a modulation method on the PDSCH, setting of the coding rates on the PDSCH and the PDCCH, setting of the precoding processing on the PDSCH and for the UE specific RS, and so on for the transmission processing unit 107 on the basis of the control signal supplied from the radio resource control unit 103. In addition, the control unit 105 generates the DCI to be transmitted on the PDCCH on the basis of the control signal supplied from the radio resource control unit 103 to supply the generated DCI to the transmission processing unit 107. The DCI transmitted on the PDCCH is, for example, the downlink assignment or the uplink grant.

The control unit 105 controls allocation of an UL PRB on the PUSCH, allocation of a resource on the PUCCH, setting of the modulation methods on the PUSCH and the PUCCH, setting of the coding rate on the PUSCH, the detecting process on the PUCCH, setting of the code sequence on the PUCCH, allocation of a resource on the PRACH, allocation of a resource to the SRS, and so on for the reception processing unit 101 on the basis of the control signal supplied from the radio resource control unit 103. In addition, the control unit 105 supplies the UCI that is transmitted from the mobile station apparatus 5 on the PUCCH and that is received by the reception processing unit 101 to the radio resource control unit 103.

Furthermore, the control unit 105 receives the information indicating the incoming timing of the detected preamble sequence and the information indicating the synchronization shift on the uplink, detected from the received SRS, from the reception processing unit 101 and calculates an adjustment value of the uplink transmission timing (timing advance (TA), timing adjustment, or timing alignment) (a TA value). The information (a TA command) indicating the calculated adjustment value of the uplink transmission timing is indicated to the mobile station apparatus 5 through the transmission processing unit 107.

The transmission processing unit 107 generates signals to be transmitted on the PDCCH and the PDSCH on the basis of the control signal supplied from the control unit 105 to transmit the signals through a transmit antenna 111. The transmission processing unit 107 transmits, for example, the information concerning the configuration of the CSI-RS, the information indicating the parameters (the periodicPHR-Timer, the prohibitPHR-Timer, and the dl-PathlossChange) concerning the power head room reporting, the information indicating the downlink reference signal (the CRS or the CSI-RS) used in the measurement of the path loss, the information indicating the values of part of the parameters concerning the PUSCH transmit power, the information indicating the values of part of the parameters concerning the PUCCH transmit power, which are supplied from the radio resource control unit 103, and the information data supplied from the higher layer to the mobile station apparatus 5 on the PDSCH and transmits the DCI supplied from the control unit 105 to the mobile station apparatus 5 on the PDCCH. It is assumed in the following description that the information data includes information concerning the control of several kinds for simplicity. The transmission processing unit 107 will be described in detail below.

### <Configuration of Transmission Processing Unit 107 in Base Station Apparatus 3>

The transmission processing unit 107 in the base station apparatus 3 will now be described in detail. FIG. 2 is a block diagram schematically illustrating the configuration of the transmission processing unit 107 in the base station apparatus 3 according to the embodiment of the present invention. Referring to FIG. 2, the transmission processing unit 107 includes multiple physical downlink shared channel processing modules 201-1 to 201-M (the physical downlink shared channel processing modules 201-1 to 201-M are hereinafter collectively referred to as a physical downlink shared channel processing module 201), multiple physical downlink control channel processing modules 203-1 to 203-M (the physical downlink control channel processing modules 203-1 to 203-M are hereinafter collectively referred to as a physical downlink control channel processing module 203), a downlink pilot channel processor 205, a precoding processor 231, a multiplexer 207, an Inverse Fast Fourier Transform (IFFT) module 209, a guard interval (GI) inserter 211, a digital-to-analog (D/A) converter 213, a transmission radio-frequency (RF) module 215, and the transmit antenna 111. Since the physical downlink shared channel processing modules 201 have the same configuration and function and the physical downlink control channel processing modules 203 have the same configuration and function, one of the physical downlink shared channel processing modules 201 and one of the physical downlink control channel processing modules 203 are described as representatives. It is assumed that the transmit antenna 111 includes multiple antenna ports for simplicity.

As illustrated in FIG. 2, the physical downlink shared channel processing module 201 includes a turbo coder 219, a data modulator 221, and a precoding processor 229. As illustrated in FIG. 2, the physical downlink control channel processing module 203 includes a convolutional coder 223, a QPSK modulator 225, and a precoding processor 227. The physical downlink shared channel processing module 201 performs baseband signal processing for transmitting the information data for the mobile station apparatus 5 in the OFDM method. The turbo coder 219 performs turbo coding for improving error tolerance of data on the information data that is input at the coding rate supplied from the control unit 105 to supply the information data to the data modulator 221. The data modulator 221 modulates the data coded by the turbo coder 219 with the modulation method supplied from the control unit 105, for example, the modulation method, such as the Quadrature Phase Shift Keying (QPSK), 16 Quadrature Amplitude Modulation (16QAM), or 64 Quadrature Amplitude Modulation (64QAM), to generate the signal sequence of modulation symbols. The data modulator 221 supplies the generated signal sequence to the precoding processor 229. The precoding processor 229 performs the precoding processing (the beamforming processing) on the signal supplied from the data modulator 221 to supply the signal to the multiplexer 207. In the precoding processing, it is preferable to perform, for example, the phase rotation on the signal to be generated so that the mobile station apparatus 5 is capable of efficiently receiving the signal (for example, so that the receive power is maximized or the interference is minimized).

The physical downlink control channel processing module 203 performs baseband signal processing for transmitting the DCI supplied from the control unit 105 in the OFDM method. The convolutional coder 223 performs convolutional coding for improving the error tolerance of the DCI on the basis of the coding rate supplied from the control unit 105. The DCI is controlled in units of bits. The convolutional coder 223 also performs rate matching for adjusting the number of output bits for the bits subjected to the convolutional coding on the basis of the coding rate supplied from the control unit 105. The convolutional coder 223 supplies the coded DCI to the QPSK modulator 225. The QPSK modulator 225 modulates the DCI coded by the convolutional coder 223 with the QPSK modulation method to supply the signal sequence of the modulated modulation symbols to the precoding processor 227. The precoding processor 227 performs the precoding processing on the signal supplied from the QPSK modulator 225 to supply the signal to the multiplexer 207. The precoding processor 227 may supply the signal supplied from the QPSK modulator 225 to the multiplexer 207 without performing the precoding processing on the signal.

The downlink pilot channel processor 205 generates the downlink reference signal (the CRS, the UE specific RS, or the CSI-RS), which is a known signal in the mobile station apparatus 5, to supply the generated downlink reference signal to the precoding processor 231. The precoding processor 231 supplies the CRS or the CSI-RS supplied from the downlink pilot channel processor 205 to the multiplexer 207 without performing the precoding process on the CRS or the CSI-RS. The precoding processor 231 performs the precoding processing on the UE specific RS supplied from the downlink pilot channel processor 205 to supply the UE specific RS subjected to the precoding processing to the multiplexer 207. The precoding processor 231 performs processing similar to the processing performed on the PDSCH in the precoding processor 229 and/or processing similar to the processing performed on the PDCCH in the precoding processor 227 on the UE specific RS. Accordingly, in the demodulation of the PDSCH signal or the PDCCH signal to which the precoding processing is applied in the mobile station apparatus 5, an equalization channel in which the channel variation on the downlink is combined with the phase rotation by the precoding processor 229 or the precoding processor 227 is able to be estimated from the UE specific RS. In other words, it is not necessary for the base station apparatus 3 to notify the mobile station apparatus 5 of the information about the precoding processing (the amount of phase rotation) in the precoding processor 229 or the precoding processor 227 and the mobile station apparatus 5 is capable of demodulating the signal subjected to the precoding processing (transmitted by the cooperative multipoint communication). For example, when the precoding processing is not used for the PDSCH on which the UE specific RS is used to perform the demodulation process, such as the channel compensation, the precoding processor 231 supplies the UE specific RS to the multiplexer 207 without performing the precoding processing on the UE specific RS.

The multiplexer 207 multiplexes the signal supplied from the downlink pilot channel processor 205, the signal supplied from the physical downlink shared channel processing module 201, and the signal supplied from the physical downlink control channel processing module 203 on the downlink subframe in accordance with an instruction from the control unit 105. The control unit 105 controls the processing in the multiplexer 207 on the basis of the control signals concerning the allocation of the DL PRB on the PDSCH and the allocation of the resource on the PDCCH, which are set by the radio resource control unit 103 and which are supplied to the control unit 105.

The multiplexer 207 basically performs the multiplexing on the PDSCH and the PDCCH by the time multiplexing, as illustrated in FIG. 9. The multiplexer 207 performs the multiplexing between the downlink pilot channel and other channels with the time and frequency multiplexing. The multiplexer 207 may multiplex the PDSCH for each mobile station apparatus 5 in units of DL PRB pairs and may multiplex the PDSCH using multiple DL PRB pairs for one mobile station apparatus 5. The multiplexer 207 supplies the multiplexed signal to the IFFT module 209.

The IFFT module 209 performs Inverse Fast Fourier Transform on the signal multiplexed by the multiplexer 207 and performs the modulation in the OFDM method to supply the signal to the GI inserter 211. The GI inserter 211 adds guard interval to the signal subjected to the modulation in the OFDM method in the IFFT module 209 to generate a baseband digital signal composed of the symbols in the OFDM method. As is known in the art, the guard interval is generated by duplicating part of the beginning or the end of the OFDM symbol to be transmitted. The GI inserter 211 supplies the generated baseband digital signal to the D/A converter 213. The D/A converter 213 converts the baseband digital signal supplied from the GI inserter 211 into an analog signal to supply the analog signal to the transmission RF module 215. The transmission RF module 215 generates in-phase components and orthogonal components of an intermediate frequency from the analog signal supplied from the D/A converter 213 to remove extra frequency components for the intermediate frequency band. Next, the transmission RF module 215 converts (up-converts) the intermediate-frequency signal into a high-frequency signal, removes extra frequency components, and amplifies the power to supply the signal to the mobile station apparatus 5 via the transmit antenna 111.

### <Configuration of Reception Processing Unit 101 in Base Station Apparatus 3>

The reception processing unit 101 in the base station apparatus 3 will now be described in detail. FIG. 3 is a block diagram schematically illustrating the configuration of the reception processing unit 101 in the base station apparatus 3 according to the embodiment of the present invention. Referring to FIG. 3, the reception processing unit 101 includes a reception RF module 301, an analog-to-digital (A/D) converter 303, a symbol timing detector 309, a GI remover 311, an FFT module 313, a subcarrier demapper 315, a channel estimator 317, a PUSCH channel equalizer 319, a PUCCH channel equalizer 321, an IDFT module 323, a data demodulator 325, a turbo decoder 327, a physical uplink control channel detector 329, a preamble detector 331, and an SRS processor 333.

The reception RF module 301 appropriately amplifies the signal received through the receive antenna 109, converts (down-converts) the signal into an intermediate frequency, removes unnecessary frequency components, controls the amplification level so as to appropriately keep the signal level, and performs orthogonal demodulation on the basis of the in-phase components and the orthogonal components of the received signal. The reception RF module 301 supplies an analog signal subjected to the orthogonal demodulation to the A/D converter 303. The A/D converter 303 converts the analog signal subjected to the orthogonal demodulation in the reception RF module 301 into a digital signal to supply the digital signal resulting from the conversion to the symbol timing detector 309, the GI remover 311, and the preamble detector 331.

The symbol timing detector 309 detects the timing of the symbols on the basis of the signal supplied from the A/D converter 303 to supply a control signal indicating the detected timing of a symbol boundary to the GI remover 311. The GI remover 311 removes a part corresponding to the guard interval from the signal supplied from the A/D converter 303 on the basis of the control signal supplied from the symbol timing detector 309 to supply the remaining signal to the FFT module 313. The FFT module 313 performs fast Fourier transform on the signal supplied from the GI remover 311 and performs the demodulation in the DFT-Spread-OFDM method to supply the signal to the subcarrier demapper 315. The number of points in the FFT module 313 is equal to the number of points in an IFFT module in the mobile station apparatus 5 described below.

The subcarrier demapper 315 demaps the signal demodulated by the FFT module 313 to the DM RS, the SRS, the PUSCH signal, and the PUCCH signal on the basis of the control signal supplied from the control unit 105. The subcarrier demapper 315 supplies the DM RS resulting from the demapping to the channel estimator 317, supplies the SRS resulting from the demapping to the SRS processor 333, supplies the PUSCH signal resulting from the demapping to the PUSCH channel equalizer 319, and supplies the PUCCH signal resulting from the demapping to the PUCCH channel equalizer 321.

The channel estimator 317 estimates the channel variation using the DM RS resulting from the demapping in the subcarrier demapper 315 and a known signal. The channel estimator 317 supplies the estimated channel estimation value to the PUSCH channel equalizer 319 and the PUCCH channel equalizer 321. The PUSCH channel equalizer 319 equalizes the amplitude and the phase of the PUSCH signal resulting from the demapping in the subcarrier demapper 315 on the basis of the channel estimation value supplied from the channel estimator 317. Here, the equalization represents a process of restoring the channel variation of the signal during the radio communication. The PUSCH channel equalizer 319 supplies the adjusted signal to the IDFT module 323.

The IDFT module 323 performs inverse discrete Fourier transform on the signal supplied from the PUSCH channel equalizer 319 to supply the signal to the data demodulator 325. The data demodulator 325 demodulates the PUSCH signal subjected to the inverse discrete Fourier transform in the IDFT module 323 to supply the PUSCH signal resulting from the demodulation to the turbo decoder 327. The demodulation here corresponds to the modulation method used in a data modulator in the mobile station apparatus 5 and the modulation method is supplied from the control unit 105. The turbo decoder 327 decodes the information data from the PUSCH signal that is demodulated in the data demodulator 325 and that is supplied from the data demodulator 325. The coding rate is supplied from the control unit 105.

The PUCCH channel equalizer 321 equalizes the amplitude and the phase of the PUCCH signal resulting from the demapping in the subcarrier demapper 315 on the basis of the channel estimation value supplied from the channel estimator 317. The PUCCH channel equalizer 321 supplies the signal resulting from the equalization to the physical uplink control channel detector 329.

The physical uplink control channel detector 329 demodulates and decodes the signal supplied from the PUCCH channel equalizer 321 to detect the UCI. The physical uplink control channel detector 329 performs a process of demultiplexing the signal subjected to the code multiplexing in the frequency domain and/or the frequency domain. The physical uplink control channel detector 329 performs a process of detecting the ACK/NACK, the SR, and the CQI from the PUCCH signal subjected to the code multiplexing in the frequency domain and/or the time domain using the code sequence used at the transmission side. Specifically, the physical uplink control channel detector 329 multiplies the signal for each PUCCH subcarrier by each code in the code sequence and, then, combines the signals resulting from the multiplication by each code as the detection process using the code sequence in the frequency domain, that is, the process of demultiplexing the signal subjected to the code multiplexing in the frequency domain. Specifically, the physical uplink control channel detector 329 multiplies the signal for each PUCCH SC-FDMA symbol by each code in the code sequence and, then, combines the signals resulting from the multiplication by each code as the detection process using the code sequence in the time domain, that is, the process of demultiplexing the signal subjected to the code multiplexing in the time domain. The physical uplink control channel detector 329 sets the detection process for the PUCCH signal on the basis of the control signal supplied from the control unit 105.

The SRS processor 333 measures the channel quality using the SRS supplied from the subcarrier demapper 315 to supply the result of the measurement of the channel quality of the UL PRB to the control unit 105. The SRS processor 333 is instructed by the control unit 105 which UL PRB in which uplink subframe the measurement of the channel quality in the mobile station apparatus 5 is to be performed for the signal in. In addition, the SRS processor 333 detects the synchronization shift on the uplink using the SRS supplied from the subcarrier demapper 315 to supply the information indicating the synchronization shift on the uplink (synchronization shift information) to the control unit 105. The SRS processor 333 may perform a process of detecting the synchronization shift on the uplink from the receive signal in the time domain. Specifically, the SRS processor 333 may perform a process similar to the process performed in the preamble detector 331 described below.

The preamble detector 331 performs a process of detecting (receiving) the preamble transmitted on the receive signal corresponding to the PRACH on the basis of the signal supplied from the A/D converter 303. Specifically, the preamble detector 331 performs correlation processing with a replica signal that may be transmitted and is generated by using each preamble sequence to the receive signals at various timings in the guard time. For example, if the correlation value is higher a predetermined threshold value, the preamble detector 331 determines that the same signal as the preamble sequence used in the generation of the replica signal used in the correlation processing is transmitted from the mobile station apparatus 5. The preamble detector 331 determines that the timing having the highest correlation value to be the incoming timing of the preamble sequence. The preamble detector 331 generates preamble detection information at least including the information indicating the detected preamble sequence and the information indicating the incoming timing to supply the preamble detection information to the control unit 105.

The control unit 105 controls the subcarrier demapper 315, the data demodulator 325, the turbo decoder 327, the channel estimator 317, and the physical uplink control channel detector 329 on the basis of the control information (DCI) transmitted from the base station apparatus 3 to the mobile station apparatus 5 on the PDCCH and the control information transmitted from the base station apparatus 3 to the mobile station apparatus 5 on the PDSCH. In addition, the control unit 105 recognizes the resource (the uplink subframe, the UL PRB, the code sequence in the frequency domain, the code sequence in the time domain, or the preamble sequence) of which the PRACH, the PUSCH, the PUCCH, or the SRS that is transmitted from each mobile station apparatus 5 (that may be transmitted from each mobile station apparatus 5) is composed on the basis of the control information transmitted from the base station apparatus 3 to the mobile station apparatus 5.

### <Entire Configuration of Mobile Station Apparatus 5>

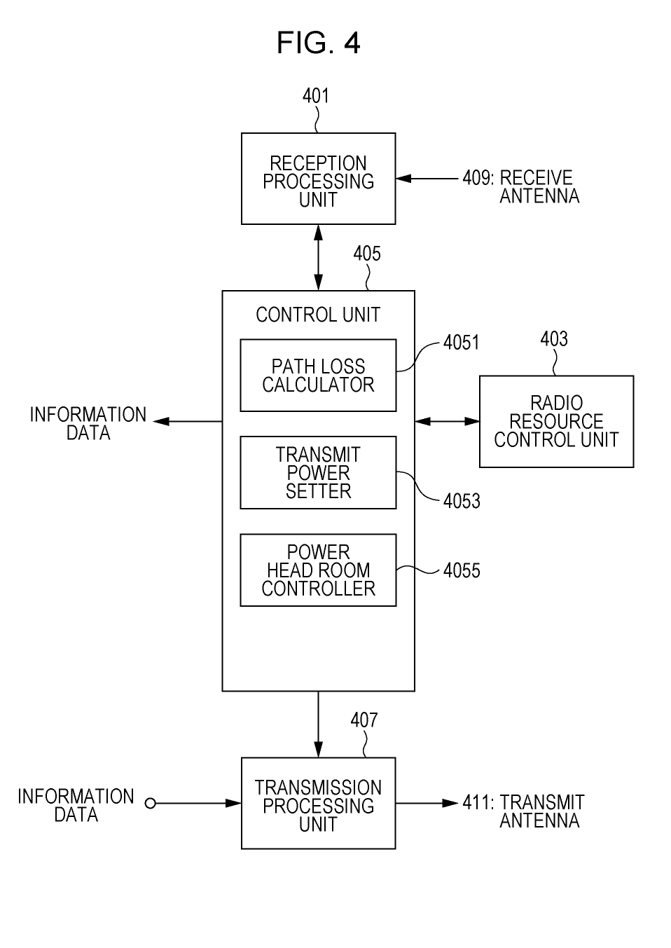

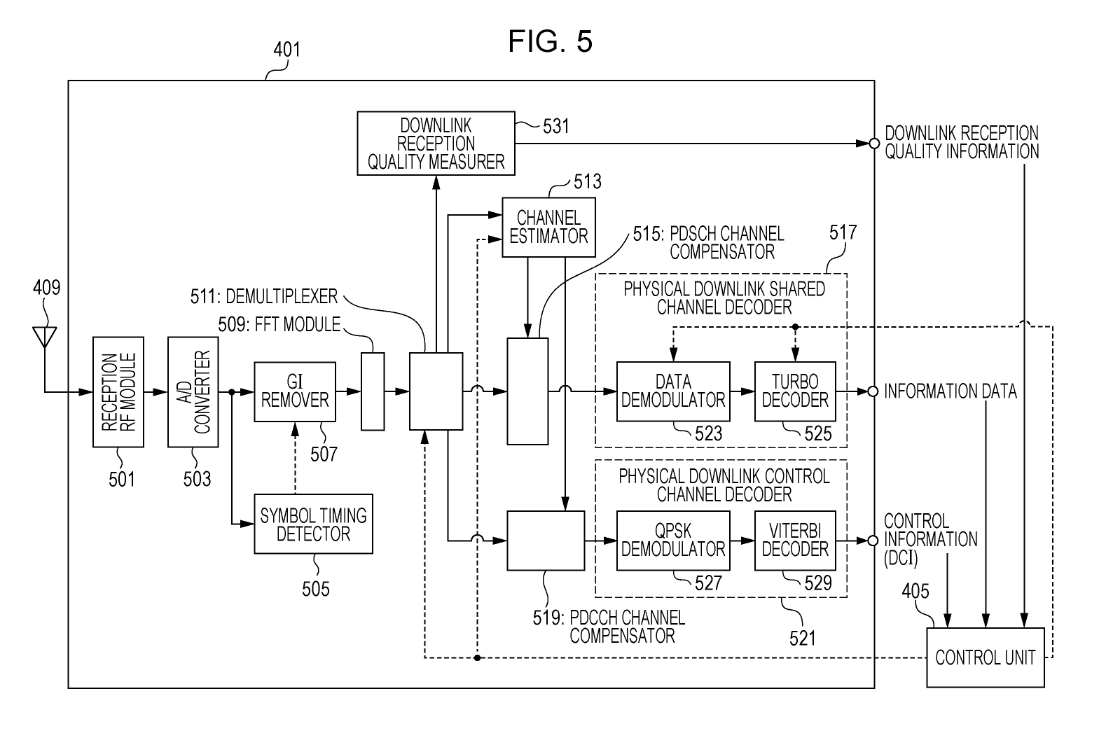

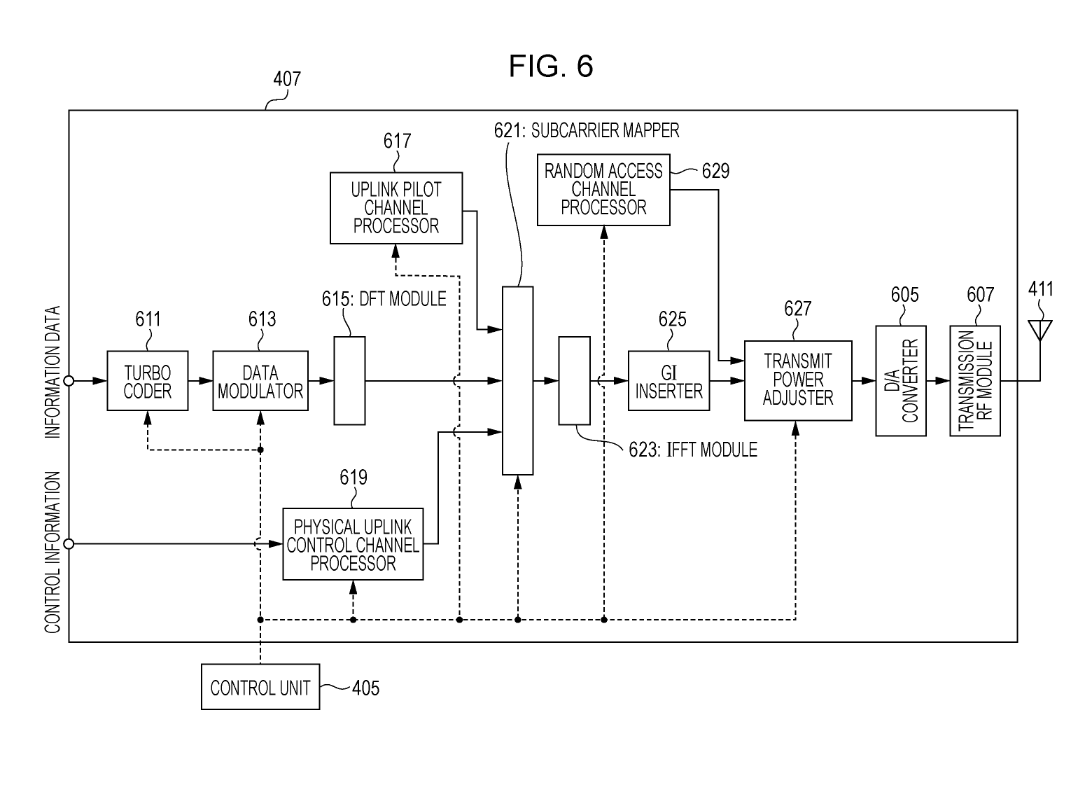

The configuration of the mobile station apparatus 5 according to an embodiment will now be described with reference to FIG. 4, FIG. 5, and FIG. 6. FIG. 4 is a block diagram schematically illustrating the configuration of the mobile station apparatus 5 according to the embodiment of the present invention. Referring to FIG. 4, the mobile station apparatus 5 includes a reception processing unit (a first reception processing unit) 401, a radio resource control unit (a first radio resource control unit) 403, a control unit (a first control unit) 405, and a transmission processing unit (a first transmission processing unit) 407. The control unit 405 includes a path loss calculator 4051, a transmit power setter 4053, and a power head room controller 4055.

The reception processing unit 401 receives a signal from the base station apparatus 3 to demodulate and decode the receive signal in accordance with an instruction from the control unit 405. When the reception processing unit 401 detects the PDCCH signal for the mobile station apparatus 5, the reception processing unit 401 supplies the DCI that is acquired by decoding the PDCCH signal to the control unit 405. For example, the reception processing unit 401 supplies the control information concerning the PUCCH resource included on the PDCCH to the control unit 405. In addition, the reception processing unit 401 supplies the information data that is acquired by decoding the PDSCH signal for the mobile station apparatus 5 to a higher layer via the control unit 405 on the basis of an instruction from the control unit 405 after the DCI included on the PDCCH is supplied to the control unit 405. The downlink assignment in the DCI included on the PDCCH includes the information indicating the allocation of the PDSCH resource. Furthermore, the reception processing unit 401 supplies the control information that is acquired by decoding the PDSCH and that is generated by the radio resource control unit 103 in the base station apparatus 3 to the control unit 405 and to the radio resource control unit 403 in the mobile station apparatus 5 via the control unit 405. For example, the control information generated in the radio resource control unit 103 in the base station apparatus 3 includes information concerning the configuration of the CSI-RS, information indicating the downlink reference signal used in the measurement of the path loss, information indicating the values of the parameters concerning the power head room reporting, information indicating the values of part of the parameters concerning the PUSCH transmit power, and information indicating the values of part of the parameters concerning the PUCCH transmit power.

Furthermore, the reception processing unit 401 supplies a cyclic redundancy check (CRC) code included on the PDSCH to the control unit 405. The transmission processing unit 107 in the base station apparatus 3 generates the CRC code from the information data to transmit the information data and the CRC code on the PDSCH, although this is omitted in the description of the base station apparatus 3. The CRC code is used for determining whether the data included on the PDSCH is wrong or not. For example, if the information generated from the data by using a predetermined generator polynomial in the mobile station apparatus 5 is equal to the CRC code that is generated in the base station apparatus 3 and that is transmitted on the PDSCH, it is determined that the data is not wrong. If the information generated from the data by using the predetermined generator polynomial in the mobile station apparatus 5 is different from the CRC code that is generated in the base station apparatus 3 and that is transmitted on the PDSCH, it is determined that the data is wrong.

Furthermore, the reception processing unit 401 measures the downlink reception quality (reference signal received power (RSRP)) to supply the result of the measurement to the control unit 405. The reception processing unit 401 measures (calculates) the RSRP from the CRS or the CSI-RS on the basis of an instruction from the control unit 405. The reception processing unit 401 will be described in detail below.

The control unit 405 includes the path loss calculator 4051, the transmit power setter 4053, and the power head room controller 4055. The control unit 405 confirms the data that is transmitted from the base station apparatus 3 on the PDSCH and that is received by the reception processing unit 401, supplies the information data in the data to the higher layer, and controls the reception processing unit 401 and the transmission processing unit 407 on the basis of the control information in the data, which is generated in the radio resource control unit 103 in the base station apparatus 3. In addition, the control unit 405 controls the reception processing unit 401 and the transmission processing unit 407 on the basis of an instruction from the radio resource control unit 403. For example, the control unit 405 sets the downlink reference signal with which the RSRP is measured in the reception processing unit 401 on the basis of the information indicating the downlink reference signal used in the measurement of the path loss. For example, the control unit 405 causes the transmission processing unit 407 to transmit the signal including the information about the power head room on the PUSCH instructed by the radio resource control unit 403.

Furthermore, the control unit 405 controls the reception processing unit 401 and the transmission processing unit 407 on the basis of the DCI that is transmitted from the base station apparatus 3 on the PDCCH and that is received by the reception processing unit 401. Specifically, the control unit 405 controls the reception processing unit 401 on the basis of the downlink assignment that is detected and controls the transmission processing unit 407 on the basis of the uplink grant that is detected. Furthermore, the control unit 405 compares the data supplied from the reception processing unit 401 using the predetermined generator polynomial with the CRC code supplied from the reception processing unit 401 and determines whether the data is wrong to generate the ACK/NACK. Furthermore, the control unit 405 generates the SR or the CQI on the basis of an instruction from the radio resource control unit 403. Furthermore, the control unit 405 controls the transmission timing of the signal from the transmission processing unit 407 on the basis of, for example, an adjustment value of the uplink transmission timing, indicated from the base station apparatus 3.

The path loss calculator 4051 calculates the path loss using the RSRP supplied from the reception processing unit 401. For example, the path loss is calculated by subtracting an averaged RSRP value from the transmit power value of the downlink reference signal. For example, the averaging is performed by adding a value resulting from multiplication of the value resulting from the averaging by (1-filterCoefficient) to a value resulting from multiplication of a value that is newly measured by filterCoefficient. FilterCoefficient is a certain filter coefficient. The value of the filter coefficient (filterCoefficient) used in the mobile station apparatus 5 is set by the base station apparatus 3 or the RRH 4. The path loss calculator 4051 supplies the information about the calculated path loss to the transmit power setter 4053 and the power head room controller 4055.

The transmit power setter 4053 sets the uplink transmit power. The transmit power setter 4053 sets a desired PUSCH transmit power on the basis of, for example, the path loss supplied from the path loss calculator 4051, the coefficient by which the path loss is multiplied, the parameter based on the number of UL PRBs allocated on the PUSCH, the parameters specific to the cell and specific to the mobile station apparatus which are indicated from the base station apparatus 3 or the RRH 4 in advance, and the parameter based on the transmit power control command indicated from the base station apparatus 3 or the RRH 4. The transmit power setter 4053 sets a desired PUCCH transmit power on the basis of, for example, the path loss supplied from the path loss calculator 4051, the parameter based on the signal structure on the PUCCH, the parameter based on the amount of information transmitted on the PUCCH, the parameters specific to the cell and specific to the mobile station apparatus which are indicated from the base station apparatus 3 or the RRH 4 in advance, and the parameter based on the transmit power control command indicated from the base station apparatus 3 or the RRH 4. The transmit power setter 4053 sets a desired SRS transmit power on the basis of, for example, the path loss supplied from the path loss calculator 4051, the coefficient by which the path loss is multiplied, the parameter based on the number of UL PRBs allocated to the SRS, the parameters specific to the cell and specific to the mobile station apparatus which are indicated from the base station apparatus 3 or the RRH 4 in advance, the offset indicated from the base station apparatus 3 or the RRH 4 in advance, and the parameter based on the transmit power control command indicated from the base station apparatus 3 or the RRH 4. The transmit power setter 4053 sets the transmit power equal to that on the physical channel on which the DM RS is allocated for the DM RS. A configuration in which the various parameters described above are set from the base station apparatus 3 or the RRH 4 by using the signaling, a configuration in which the values of the various parameters described above are uniquely set in accordance with the specifications, or a configuration in which the values of the various parameters described above are set depending on other various factors may be adopted. The transmit power setter 4053 causes the transmission processing unit 407 to use the desired transmit power value that is set or the transmit power value that is configured in the mobile station apparatus 5 in advance. The transmit power setter 4053 causes the transmission processing unit 407 to select a lower value, among the transmit power value that is configured in the mobile station apparatus 5 in advance and the desired transmit power value, and use the selected transmit power value. In addition, the transmit power setter 4053 supplies the desired transmit power value that is set to the power head room controller 4055.

In the transmit power setter 4053, two modes are used in the setting of the parameter based on the transmit power control command. In one mode (an Accumulation mode), the values of the transmit power control commands that are indicated are accumulated. In the other mode (an Absolute mode), only the value of the most recent transmit power control command is used without the accumulation of the values of the multiple transmit power control commands that are indicated. For example, either of the Accumulation mode and the Absolute mode is set in the mobile station apparatus 5 for the PUSCH by using the RRC signaling and the Accumulation mode is set in the mobile station apparatus 5 for the PUCCH. When the Accumulation mode is used, the accumulated value of the transmit power control commands is reset (reset to zero) upon switching (setting, configuration, change, resetting, reconfiguration, or rechange) of the path loss reference. Accordingly, it is possible to appropriately perform the adjustment using the transmit power control command in the transmission power control using the path loss.

The power head room controller 4055 controls the power head room reporting. The power head room is information concerning the margin of the transmit power. The power head room controller 4055 controls the transmission of the power head room using the parameters (the periodicPHR-Timer, the prohibitPHR-Timer, and the dl-PathlossChange) concerning the power head room reporting and the path loss supplied from the path loss calculator 4051. In addition, the power head room controller 4055 determines to transmit the power head room upon switching of the kind (the CRS or the CSI-RS) of the downlink reference signal used in the calculation in the path loss calculator 4051 on the basis of the information indicated from the base station apparatus 3 or the RRH 4. The power head room controller 4055 calculates the value of the power head room using the desired transmit power supplied from the transmit power setter 4053 and the nominal UE maximum transmit power. For example, the power head room controller 4055 subtracts the value of the transmit power supplied from the transmit power setter 4053 from the value of the nominal UE maximum transmit power to calculate the value of the power head room. The power head room controller 4055 causes the transmission processing unit 407 to transmit the information about the power head room on the PUSCH if the power head room controller 4055 determines to transmit the power head room.

Among the parameters concerning the transmit power, the parameters specific to the cell and specific to the mobile station apparatus, the coefficient by which the path loss is multiplied, and the offset used for the SRS are indicated from the base station apparatus 3 on the PDSCH and the transmit power control command is indicated from the base station apparatus 3 on the PUCCH. The other parameters are calculated from the receive signal or are calculated and set on the basis of other information. The transmit power control command for the PUSCH is included the uplink grant and the transmit power control command for the PUCCH is included in the downlink assignment. The control unit 405 controls the signal structure on the PUCCH depending on the kind of the UCI to be transmitted and controls the signal structure on the PUCCH used in the transmit power setter 4053. The various parameters that are indicated from the base station apparatus 3 and that concerns the transmit power are appropriately stored in the radio resource control unit 403 and the stored values are supplied to the transmit power setter 4053.

The radio resource control unit 403 stores and holds the control information that is generated in the radio resource control unit 103 in the base station apparatus 3 and that is indicated from the base station apparatus 3 and controls the reception processing unit 401 and the transmission processing unit 407 via the control unit 405. In other words, the radio resource control unit 403 has a memory function to hold the various parameters and so on. For example, the radio resource control unit 403 holds the parameters concerning the transmit power on the PUSCH and the PUCCH and the transmit power of the SRS and supplies the control signal instructing that the parameter indicated from the base station apparatus 3 is used in the transmit power setter 4053 to the control unit 405. For example, the radio resource control unit 403 holds the information about the kind of the downlink reference signal used in the measurement of the path loss and supplies the control signal instructing that the reception quality (the RSRP) used in the calculation of the path loss is measured from the downlink reference signal of the kind indicated from the base station apparatus 3 or the RRH 4 to the control unit 405.

The transmission processing unit 407 transmits the signal resulting from the coding and the modulation of the information data and the UCI to the base station apparatus 3 via a transmit antenna 411 using the PUSCH and/or PUCCH resource in accordance with an instruction from the control unit 405, along with the DM RS. In addition, the transmission processing unit 407 transmits the SRS in accordance with an instruction from the control unit 405. Furthermore, the transmission processing unit 407 transmits the preamble to the base station apparatus 3 or the RRH 4 using the PRACH resource in accordance with an instruction from the control unit 405. Furthermore, the transmission processing unit 407 sets the transmit power on the PUSCH, the PUSCH, and the PRACH (a description is omitted) and the transmit power of the DM RS and the SRS in accordance with an instruction from the control unit 405. The transmission processing unit 407 will be described in detail below.

### <Reception Processing Unit 401 in Mobile Station Apparatus 5>

The reception processing unit 401 in the mobile station apparatus 5 will now be described in detail. FIG. 5 is a block diagram schematically illustrating the configuration of the reception processing unit 401 in the mobile station apparatus 5 according to the embodiment of the present invention. Referring to FIG. 5, the reception processing unit 401 includes a reception RF module 501, an A/D converter 503, a symbol timing detector 505, a GI remover 507, an FFT module 509, a demultiplexer 511, a channel estimator 513, a PDSCH channel compensator 515, a physical downlink shared channel decoder 517, a PDCCH channel compensator 519, a physical downlink control channel decoder 521, and a downlink reception quality measurer 531. As illustrated in FIG. 5, the physical downlink shared channel decoder 517 includes a data demodulator 523 and a turbo decoder 525. As illustrated in FIG. 5, the physical downlink control channel decoder 521 includes a QPSK demodulator 527 and a Viterbi decoder 529.

The reception RF module 501 appropriately amplifies the signal received through a receive antenna 409, converts (down-converts) the signal into an intermediate frequency, removes unnecessary frequency components, controls the amplification level so as to appropriately keep the signal level, and performs the orthogonal demodulation on the basis of the in-phase components and the orthogonal components of the received signal. The reception RF module 501 supplies an analog signal subjected to the orthogonal demodulation to the A/D converter 503.

The A/D converter 503 converts the analog signal subjected to the orthogonal demodulation in the reception RF module 501 into a digital signal to supply the digital signal resulting from the conversion to the symbol timing detector 505 and the GI remover 507. The symbol timing detector 505 detects the timing of the symbols on the basis of the digital signal converted in the A/D converter 503 to supply a control signal indicating the detected timing of a symbol boundary to the GI remover 507. The GI remover 507 removes a part corresponding to the guard interval from the digital signal supplied from the A/D converter 503 on the basis of the control signal supplied from the symbol timing detector 505 to supply the remaining signal to the FFT module 509. The FFT module 509 performs the fast Fourier transform to the signal supplied from the GI remover 507 and performs the demodulation in the OFDM method to supply the signal to the demultiplexer 511.

The demultiplexer 511 demultiplexes the signal demodulated by the FFT module 509 into the PDCCH signal and the PDSCH signal on the basis of the control signal supplied from the control unit 405. The demultiplexer 511 supplies the PDSCH signal resulting from the demultiplexing to the PDSCH channel compensator 515 and the PDCCH signal resulting from the demultiplexing to the PDCCH channel compensator 519. In addition, the demultiplexer 511 demultiplexes the downlink resource element in which the downlink pilot channel is arranged to supply the downlink reference signal (the CRS or UE specific RS) on the downlink pilot channel to the channel estimator 513. Furthermore, the demultiplexer 511 supplies the downlink reference signal (CRS or the CSI-RS) on the downlink pilot channel to the downlink reception quality measurer 531. The demultiplexer 511 supplies the PDCCH signal to the PDCCH channel compensator 519 and the PDSCH signal to the PDSCH channel compensator 515.

The channel estimator 513 estimates the channel variation using the downlink reference signal (the CRS or the UE specific RS) on the downlink pilot channel, resulting from the demultiplexing in the demultiplexer 511, and a known signal to supply a channel compensation value for adjusting the amplitude and the phase to compensate the channel variation to the PDSCH channel compensator 515 and the PDCCH channel compensator 519. The channel estimator 513 independently estimates the channel variation using each of the CRS and the UE specific RS to output the channel compensation value. Alternatively, the channel estimator 513 estimates the channel variation using the CRS or the UE specific RS on the basis of an instruction from the base station apparatus 3 to output the channel compensation value. In the base station apparatus 3 and the RRH 4, the precoding processing common to the processing used for the UE specific RS is performed for the physical channels (the PDSCH and the E-PDCCH) on which the channel compensation is performed by using the UE specific RS in the mobile station apparatus 5.

The PDSCH channel compensator 515 adjusts the amplitude and the phase of the PDSCH signal resulting from the demultiplexing in the demultiplexer 511 in accordance with the channel compensation value supplied from the channel estimator 513. For example, the PDSCH channel compensator 515 adjusts the PDSCH signal transmitted by the cooperative multipoint communication in accordance with the channel compensation value generated by the channel estimator 513 on the basis of the UE specific RS and adjusts the PDSCH signal that is transmitted not by the cooperative multipoint communication in accordance with the channel compensation value generated by the channel estimator 513 on the basis of the CRS. The PDSCH channel compensator 515 supplies the signal the channel of which is adjusted to the data demodulator 523 in the physical downlink shared channel decoder 517. The PDSCH channel compensator 515 may adjust the PDSCH signal that is transmitted not by the cooperative multipoint communication (without application of the precoding processing) in accordance with the channel compensation value generated by the channel estimator 513 on the basis of the UE specific RS.

The physical downlink shared channel decoder 517 demodulates and decodes the PDSCH on the basis of an instruction from the control unit 405 to detect the information data. The data demodulator 523 demodulates the PDSCH signal supplied from the PDSCH channel compensator 515 to supply the PDSCH signal resulting from the demodulation to the turbo decoder 525. This demodulation corresponds to the modulation method used in the data modulator 221 in the base station apparatus 3. The turbo decoder 525 decodes the information data from the PDSCH signal that is demodulated by and supplied from the data demodulator 523 to supply the information data to the higher layer via the control unit 405. The control information that is transmitted on the PDSCH and that is generated by the radio resource control unit 103 in the base station apparatus 3 and so on are also supplied to the control unit 405 and are supplied also to the radio resource control unit 403 via the control unit 405. The CRC code included on the PDSCH is also supplied to the control unit 405.

The PDCCH channel compensator 519 adjusts the amplitude and the phase of the PDCCH signal resulting from the demultiplexing in the demultiplexer 511 in accordance with the channel compensation value supplied from the channel estimator 513. For example, the PDCCH channel compensator 519 adjusts the PDCCH signal in accordance with the channel compensation value generated by the channel estimator 513 on the basis of the CRS and adjusts the PDCCH (E-PDCCH) signal transmitted by the cooperative multipoint communication in accordance with the channel compensation value generated by the channel estimator 513 on the basis of the UE specific RS. The PDCCH channel compensator 519 supplies the adjusted signal to the QPSK demodulator 527 in the physical downlink control channel decoder 521. The PDCCH channel compensator 519 may adjust the PDCCH (including the E-PDCCH) signal that is transmitted not by the cooperative multipoint communication (without application of the precoding processing) in accordance with the channel compensation value generated by the channel estimator 513 on the basis of the UE specific RS.

The physical downlink control channel decoder 521 demodulates and decodes the signal supplied from the PDCCH channel compensator 519 to detect the control data, as described below. The QPSK demodulator 527 performs QPSK demodulation to the PDCCH signal to supply the PDCCH signal to the Viterbi decoder 529. The Viterbi decoder 529 decodes the signal demodulated by the QPSK demodulator 527 to supply the DCI resulting from the decoding to the control unit 405. Here, the signal is represented in units of bits and the Viterbi decoder 529 also performs to the rate matching for adjusting the number of bits to which Viterbi decoding is to be performed for the input bits.

The mobile station apparatus 5 performs the process of detecting the DCI for the mobile station apparatus 5 on the PDCCH with multiple coding rates assumed. The mobile station apparatus 5 performs different decoding processes for different coding rates that are assumed on the PDCCH signal to acquire the DCI included on the PDCCH on which no error is detected in the CRC code added to the PDCCH with the DCI. Such processing is referred to as blind decoding. The mobile station apparatus 5 may perform the blind decoding only to the signals in part of the resources, instead of the performance of the blind decoding on the signals in all the resources in the downlink system band. An area of part of the resources to which the blind decoding is performed is referred to as a search space. The mobile station apparatus 5 may perform the blind decoding on different resources at different coding rates.

The control unit 405 determines whether the DCI supplied from the Viterbi decoder 529 is not wrong and is for the mobile station apparatus 5. If the control unit 405 determines that the DCI is not wrong and is for the mobile station apparatus 5, the control unit 405 controls the demultiplexer 511, the data demodulator 523, the turbo decoder 525, and the transmission processing unit 407 on the basis of the DCI. For example, when the DCI is the downlink assignment, the control unit 405 causes the reception processing unit 401 to decode the PDSCH signal. The CRC code is also included on the PDCCH, as on the PDSCH, and the control unit 405 uses the CRC code to determine whether the DCI on the PDCCH is wrong.

The downlink reception quality measurer 531 measures the downlink reception quality (RSRP) of the cell using the downlink reference signal (the CRS or the CSI-RS) on the downlink pilot channel to supply the information about the measured downlink reception quality to the control unit 405. In addition, the downlink reception quality measurer 531 also performs instantaneous measurement of the channel quality for the generation of the CQI to be indicated from the mobile station apparatus 5 to the base station apparatus 3 or the RRH 4. Which kind of the downlink reference signal is used to measure the RSRP is controlled by the base station apparatus 3 or the RRH 4 via the control unit 405 in the downlink reception quality measurer 531. This control is performed with the information indicating the downlink reference signal used in the measurement of the path loss. For example, the downlink reception quality measurer 531 measures the RSRP using the CRS. For example, the downlink reception quality measurer 531 measures the RSRP using the CSI-RS. For example, the downlink reception quality measurer 531 measures the RSRP using the CRS and measures the RSRP using the CSI-RS. For example, the downlink reception quality measurer 531 measures the RSPR using the CSI-RS of a certain CSI-RS configuration and measures the RSRP using the CSI-RS of another CSI-RS configuration. Alternatively, the downlink reception quality measurer 531 constantly measures the RSRP using the CRS and measures the RSRP additionally using the CSI-RS in response to an instruction from the base station apparatus 3 or the RRH 4. The downlink reception quality measurer 531 supplies the information about the measured RSRP and so on to the control unit 405.

### <Transmission Processing Unit 407 in Mobile Station Apparatus 5>

FIG. 6 is a block diagram schematically illustrating the configuration of the transmission processing unit 407 in the mobile station apparatus 5 according to the embodiment of the present invention. Referring to FIG. 6, the transmission processing unit 407 includes a turbo coder 611, a data modulator 613, a DFT module 615, an uplink pilot channel processor 617, a physical uplink control channel processor 619, a subcarrier mapper 621, an IFFT module 623, a GI inserter 625, a transmit power adjuster 627, a random access channel processor 629, a D/A converter 605, a transmission RF module 607, and the transmit antenna 411. The transmission processing unit 407 codes and modulates the information data and the UCI and generates signals to be transmitted on the PUSCH and the PUCCH to adjust the transmit power on the PUSCH and the PUCCH. The transmission processing unit 407 generates a signal to be transmitted on the PRACH to adjust the transmit power on the PRACH. The transmission processing unit 407 generates the DM RS and the SRS to adjust the transmit power of the DM RS and the SRS.

The turbo coder 611 performs the turbo coding for improving the error tolerance of data on the information data that is input at the coding rate instructed by the control unit 405 to supply the information data to the data modulator 613. The data modulator 613 modulates the coded data coded by the turbo coder 611 with the modulation method instructed by the control unit 405, for example, the modulation method, such as the QPSK, the 16QAM, or the 64QAM, to generate the signal sequence of modulation symbols. The data modulator 613 supplies the generated signal sequence of the modulation symbols to the DFT module 615. The DFT module 615 performs discrete Fourier transform on the signal supplied from the data modulator 613 to supply the signal to the subcarrier mapper 621.

The physical uplink control channel processor 619 performs the baseband signal processing for transmitting the UCI supplied from the control unit 405. The UCI supplied to the physical uplink control channel processor 619 is the ACK/NACK, the SR, or the CQI. The physical uplink control channel processor 619 performs the baseband signal processing to supply the generated signal to the subcarrier mapper 621. The physical uplink control channel processor 619 codes the information bits in the UCI to generate the signal.

In addition, the physical uplink control channel processor 619 performs the signal processing concerning the code multiplexing in the frequency domain and/or the code multiplexing in the time domain on the signal generated from the UCI. The physical uplink control channel processor 619 multiplies the PUCCH signal generated from the information bits in the ACK/NACK, the information bits in the SR, or the information bits in the CQI by the code sequence indicated from the control unit 405 to realize the code multiplexing in the frequency domain. The physical uplink control channel processor 619 multiplies the PUCCH signal generated from the information bits in the ACK/NACK or the information bits in the SR by the code sequence indicated from the control unit 405 to realize the code multiplexing in the time domain.

The uplink pilot channel processor 617 generates the SRS or the DM RS, which are known signals in the base station apparatus 3, on the basis of an instruction from the control unit 405 to supply the SRS or the DM RS to the subcarrier mapper 621.

The subcarrier mapper 621 arranges the signal supplied from the uplink pilot channel processor 617, the signal supplied from the DFT module 615, and the signal supplied from the physical uplink control channel processor 619 on the subcarrier in accordance with an instruction from the control unit 405 to supply the signal on the subcarrier to the IFFT module 623.

The IFFT module 623 performs the Inverse Fast Fourier Transform on the signal supplied from the subcarrier mapper 621 to supply the signal to the GI inserter 625. The number of points in the IFFT module 623 is larger than the number of points in the DFT module 615 and the mobile station apparatus 5 uses the DFT module 615, the subcarrier mapper 621, and the IFFT module 623 to perform the modulation in the DFT-Spread-OFDM method on the signal transmitted on the PUSCH. The GI inserter 625 adds the guard interval to the signal supplied from the IFFT module 623 to supply the signal to the transmit power adjuster 627.

The random access channel processor 629 generates the signal to be transmitted on the PRACH using the preamble sequence indicated from the control unit 405 to supply the generated signal to the transmit power adjuster 627.

The transmit power adjuster 627 adjusts the transmit power of the signal supplied from the GI inserter 625 and the signal supplied from the random access channel processor 629 on the basis of the control signal supplied from the control unit 405 (the transmit power setter 4053) to supply the signal to the D/A converter 605. In the transmit power adjuster 627, the average transmit power on the PUSCH, the PUCCH, and the PRACH and of the DM RS and the SRS is controlled for each uplink subframe.

The D/A converter 605 converts the baseband digital signal supplied from the transmit power adjuster 627 into an analog signal to supply the analog signal to the transmission RF module 607. The transmission RF module 607 generates the in-phase components and the orthogonal components of an intermediate frequency from the analog signal supplied from the D/A converter 605 to remove extra frequency components for the intermediate frequency band. Next, the transmission RF module 607 converts (up-converts) the intermediate-frequency signal into a high-frequency signal, removes extra frequency components, and amplifies the power to supply the signal to the base station apparatus 3 via the transmit antenna 411.

FIG. 7 is a flowchart illustrating an example of a process of transmitting the power head room in the mobile station apparatus 5 according to an embodiment of the present invention. The mobile station apparatus 5 determines whether the downlink reference signal used in the measurement of the path loss is switched on the basis of the information (the RRC signaling) received from the base station apparatus 3 or the RRH 4 (Step S101). If the mobile station apparatus 5 determines that the downlink reference signal used in the measurement of the path loss is switched (YES in Step S101), the mobile station apparatus 5 determines to be in the transmission wait state of the power head room (Step S102). If the mobile station apparatus 5 determines that the downlink reference signal used in the measurement of the path loss is not switched (NO in Step S101), the mobile station apparatus 5 determines not to be in the transmission wait state of the power head room (Step S103). Next, the mobile station apparatus 5 measures the path loss on the basis of the switched downlink reference signal (Step S104). Next, the mobile station apparatus 5 determines whether the PUSCH resource for new transmission is allocated (Step S105). If the mobile station apparatus 5 determines that the PUSCH resource for new transmission is allocated (YES in Step S105), the mobile station apparatus 5 transmits the power head room (Step S106). If the mobile station apparatus 5 determines that the PUSCH resource for new transmission is not allocated (NO in Step S105), the mobile station apparatus 5 does not transmit the power head room and waits for allocation of the PUSCH resource. In the description with reference to FIG. 7, a description of the processing concerning the periodicPHR-Timer, the dl-PathlossChange, and the prohibitPHR-Timer is omitted for simplicity. Step S104 does not mean that the measurement of the path loss is performed only for the power head room reporting. The processing in Step S104 may be executed before Step S102 or may be executed before Step S106.

As described above, in the embodiments of the present invention, the mobile station apparatus 5 enters the transmission wait state of the power head room upon switching (setting, configuration, change, resetting, reconfiguration, or rechange) of the downlink reference signal (the path loss reference) used in the measurement (calculation or estimation) of the path loss by the base station apparatus 3 or the RRH 4 to rapidly notify the base station apparatus 3 or the RRH 4 of the information about the power head room when the path loss used in the calculation of the uplink transmit power value is changed. Accordingly, it is possible for the base station apparatus 3 and the RRH 4 to efficiently perform the scheduling of the uplink (the allocation of the PUSCH resource and the determination of the modulation method) for the mobile station apparatus 5. In other words, since the information about the power head room is rapidly indicated to the base station apparatus 3 or the RRH 4 when the destination (the base station apparatus 3 or the RRH 4) of the uplink signal is changed, it is possible to perform the scheduling of the uplink appropriate for each destination. The mobile station apparatus 5 enters the transmission wait state of the power head room upon switching of the path loss reference to the CRS or the CSI-RS to rapidly notify the base station apparatus 3 or the RRH 4 of the information about the power head room based on the switched path loss reference. Accordingly, it is possible for the base station apparatus 3 and the RRH 4 to efficiently perform the scheduling of the uplink when the path loss based on the CRS is used in the mobile station apparatus 5 or the scheduling of the uplink when the path loss based on the CSI-RS is used in the mobile station apparatus 5. The mobile station apparatus 5 enters the transmission wait state of the power head room upon switching to the CSI-RS of a different CSI-RS configuration to rapidly notify the base station apparatus 3 or the RRH 4 of the information about the power head room based on the switched path loss reference. Accordingly, it is possible for the base station apparatus 3 and the RRH 4 to efficiently perform the scheduling of the uplink when the path loss based on the CSI-RS of each CSI-RS configuration is used in the mobile station apparatus 5.

When multiple different path loss references (the CRS and the CSI-RS) (the CSI-RS and the CSI-RS) are simultaneously set in the mobile station apparatus 5, independently configuring the various parameters (the periodicPHR-Timer, the prohibitPHR-Timer, and the dl-PathlossChange) concerning the power head room reporting for the power head room reporting based on each path loss reference and independently controlling the power head room reporting corresponding to each path loss reference allows the information about the power head room based on each path loss reference to be appropriately communicated between the mobile station apparatus 5 and the base station apparatus 3 or the RRH 4. Accordingly, it is possible for the base station apparatus 3 and the RRH 4 to efficiently perform the scheduling of the uplink (the allocation of the PUSCH resource and the determination of the modulation method) for the mobile station apparatus 5 that is capable of switching and transmitting the PUSCH on which the path loss based on each path loss reference is used in the calculation of the uplink transmit power value for each uplink subframe.

Although the case in which the transmission wait state of the power head room rapidly arises (is rapidly determined) upon switching of the downlink reference signal used in the measurement of the path loss is described in the embodiments of the present invention, the mobile station apparatus 5 may enter (determine to be in) the transmission wait state of the power head room after the results of the downlink reference signals in multiple downlink subframes are averaged to calculate the path loss in order to improve the measurement precision of the path loss. Alternatively, although the transmission wait state of the power head room rapidly arises (is determined) upon switching of the downlink reference signal used in the measurement of the path loss, the mobile station apparatus 5 may transmit the power head room after the results of the downlink reference signals in multiple downlink subframes are averaged to calculate the path loss.

The mobile station apparatus 5 is not limited to a mobile terminal and the present invention may be realized by, for example, implementing the function of the mobile station apparatus 5 in a fixed terminal.

It is noted that the downlink reference signals of different kinds include the meaning of the CSI-RSs of different CSI-RS configurations in the embodiments of the present invention.

The characteristic means of the present invention described above can also be realized by implementing the functions in an integrated circuit and controlling the functions. Specifically, the integrated circuit of the present invention is an integrated circuit mounted in the mobile station apparatus 5 communicating with the base station apparatus 3 and the RRH 4. The integrated circuit of the present invention includes a first reception processing unit that receives a signal from the base station apparatus 3 or the RRH 4, a path loss calculating unit that calculates path loss on the basis of a reference signal received by the first reception processing unit, a transmit power setting unit that sets transmit power of an uplink signal using the path loss calculated by the path loss calculating unit, and a power head room control unit that generates power head room that is information concerning a margin of the transmit power using the transmit power set by the transmit power setting unit to control transmission of the power head room. The power head room control unit determines to transmit the power head room upon switching of a kind of the reference signal used in the calculation in the path loss calculating unit.

As described above, the mobile station apparatus 5 using the integrated circuit of the present invention enters the transmission wait state of the power head room upon switching of the downlink reference signal used in the measurement of the path loss by the base station apparatus 3 or the RRH 4 to rapidly notify the base station apparatus 3 or the RRH 4 of the information about the power head room when the path loss used in the calculation of the uplink transmit power value is changed. Accordingly, it is possible for the base station apparatus 3 and the RRH 4 to efficiently perform the scheduling of the uplink for the mobile station apparatus 5.

The operation described in the embodiments of the present invention may be realized by a program. The program running in the mobile station apparatus 5 and the base station apparatus 3 according to the present invention is a program controlling a central processing unit (CPU) and so on (a program causing a computer to function) so as to realize the functions of the embodiments according to the present invention. The information processed in these apparatuses is temporarily accumulated in a random access memory (RAM) during the processing and, then, is stored in various read only memories (ROMs) or a hard disk drive (HDD). The information is read out, modified, or written by the CPU if needed. A recording medium storing the program may be any of a semiconductor medium (for example, a ROM or a non-volatile memory card), an optical recording medium (for example, a digital versatile disk (DVD), a magnetic disk (MD), a compact disc (CD), or a Blu-ray Disc (BD)), a magnetic recording medium (for example, a magnetic tape or a flexible disk), and so on. Not only the functions of the embodiments described above are realized by executing the program that is loaded but also the functions of the present invention may be realized by cooperative processing with an operating system (OS), another application program, or the like on the basis of an instruction in the program.

In distribution in the market, the program may be stored in a portable recording medium for the distribution or the program may be transferred to a server computer connected via a network, such as the Internet. In this case, a storage unit in the server computer is included in the present invention. Part or all of the mobile station apparatus 5 and the base station apparatus 3 in the embodiments described above may be realized as large scale integration (LSI), which is typically an integrated circuit. Functional blocks in the mobile station apparatus 5 and the base station apparatus 3 may be individually chipped or part or all of the functional blocks may be accumulated and chipped. The method of implementing the functions in the integrated circuit is not limitedly realized by the LSI and may be realized by a dedicated circuit or a general-purpose processor. In addition, when a technology to implement the functions in the integrated circuit, which is an alternate of the LSI, appears due to the progress in the semiconductor technology, the integrated circuit adopting the technology may be used. Each functional block in the mobile station apparatus 5 and the base station apparatus 3 may be realized by multiple circuits.

The information and the signal may be indicated by using various different technologies and methods. For example, the chip, the symbol, the bit, the signal, the information, the command, the instruction, and the data that may be referred to in the above description may be indicated by voltage, current, electromagnetic waves, a magnetic field or magnetic particles, an optical field or optical particles, or combinations of them.

Various exemplary logical blocks, processers, and algorithm steps described in association with the disclosure of the present description may be implemented as electronic hardware, computer software, or a combination of both the electronic hardware and the computer software. In order to make synonymity of the hardware and the software clear, various exemplary elements, blocks, modules, circuits, and steps have been generally described in terms of their functionality. Whether such functionality is implemented as the hardware or is implemented as the software depends on each application and restrictions in design put on the entire system. Although the persons skilled in the art may implement the functionality described above by various methods for each specific application, the determination of the implementation should not be construed as deviation from the scope of the present disclosure.

Various exemplary logical blocks and processors described in association with the disclosure of the present description may be implemented or executed as a general-purpose processor; a digital signal processor (DSP); an application specific integrated circuit (ASIC); a field programmable gate array signal (FPGA); other programmable logical devices; discrete gates or transistor logics, or discrete hardware components, which are designed so as to execute the functions described in the present description; or combinations of them. The general-purpose processor may be a microprocessor or the processor may be a conventional processor, controller, microcontroller, or state machine. The processor may be implemented as a combination of computing devices. For example, the combination is a combination of the DSP and the microprocessor, a combination of multiple microprocessors, a combination of one or more microprocessors connected to a DSP core, or a combination of other similar configurations.

The methods and the algorithm steps described in association with the disclosure of the present description may be directly embodied by the hardware, the software module that can be executed by the processor, or a combination of the hardware and the software module. The software module may exist in a RAM memory, a flash memory, a ROM memory, an electrically erasable programmable ROM (EPROM) memory, a register, a hard disk, a removable disk, a compact disk-read only memory (CD-ROM), or a recording medium in any known form in this field. The typical recording medium may be combined with the processor so that the processor can read out information from the recording medium and can write information to the recording medium. In another method, the recording medium may be integrated with the processor. The processor and the recording medium may be in the ASIC. The ASIC may exist in the mobile station apparatus (user terminal). Alternatively, the processor and the recording medium may be in the mobile station apparatus 5 as the discrete elements.

In one or more typical designs, the functions described above may be implemented as hardware, software, firmware, or combinations of them. When the functions are implemented as the software, the functions may be held or transferred as one or more instructions or codes on a computer-readable medium. The computer-readable medium includes both a communication medium and a computer recording medium, which include a medium to assist the portability of a computer program from one location to another location. The recording medium may be any commercially available medium that can be accessed by a general-purpose or special-purpose computer. The above media are only exemplary computer-readable media and are not be limitedly used. The computer-readable media may include the RAM; the ROM; the EEPROM; the CD-ROM or other optical disk media; magnetic disk media or other magnetic recording media; and media that can be accessed by a general-purpose or special-purpose computer or a general-purpose or special-purpose processor and that can be used to carry or hold desired program code means in the form of an instruction or a data structure. Any connection is appropriately referred to as the computer-readable medium. For example, when the software is transmitted from a Web site, a server, or another remote source by using a coaxial cable, an optical fiber cable, a twisted pair, a digital subscriber line (DSL), or a radio technique such as infrared radiation, radio waves, or microwaves, the coaxial cable, the optical fiber cable, the twisted pair, the DSL, and the radio technique such as the infrared radiation, the radio waves, or the microwaves are included in the definition of the media. The disks or discs used in the present description include a compact disc (CD), a laser disk (registered trademark), an optical disk, a digital versatile disk (DVD), a floppy disk (registered trademark), and a Blu-ray disk. The disks generally magnetically play back data while the discs generally optically play back data with laser beams. Combinations of the above ones should be included in the computer-readable media.

While the embodiments of the present invention are described in detail with reference to the drawings, the specific configurations are not limited to the embodiments and designs or the likes within the spirit and scope of the invention are also included in the range of the appended claims.

### REFERENCE SIGNS LIST

3 base station apparatus
4 (A TO C) RRH
5 (A TO C) mobile station apparatus
101 reception processing unit
103 radio resource control unit
105 control unit
107 transmission processing unit
109 receive antenna
111 transmit antenna
201, 201-1 TO 201-M physical downlink shared channel processing module
203, 203-1 TO 203-M physical downlink control channel processing module
205 downlink pilot channel processor
207 multiplexer
209 IFFT module
211 GI inserter
213 D/A converter
215 transmission RF module
219 turbo coder
221 data modulator
223 convolutional coder
225 QPSK modulator
227 precoding processor (for PDCCH)
229 precoding processor (for PDSCH)
231 precoding processor (for downlink pilot channel)
301 reception RF module
303 A/D converter
309 symbol timing detector
311 GI remover
313 FFT module
315 subcarrier demapper
317 channel estimator
319 channel equalizer (for PUSCH)
321 channel equalizer (for PUCCH)
323 IDFT module
325 data demodulator
327 turbo decoder
329 physical uplink control channel detector
331 preamble detector
333 SRS processor
401 reception processing unit
403 radio resource control unit
405 control unit
407 transmission processing unit
409 receive antenna
411 transmit antenna
501 reception RF module
503 A/D converter
505 symbol timing detector
507 GI remover
509 FFT module
511 demultiplexer
513 channel estimator
515 channel compensator (for PDSCH)
517 physical downlink shared channel decoder
519 channel compensator (for PDCCH)
521 physical downlink control channel decoder
523 data demodulator
525 turbo decoder
527 QPSK demodulator
529 Viterbi decoder
531 downlink reception quality measurer
605 D/A converter
607 transmission RF module
611 turbo coder
613 data modulator
615 DFT module
617 uplink pilot channel processor
619 physical uplink control channel processor
621 subcarrier mapper
623 IFFT module
625 GI inserter
627 transmit power adjuster
629 random access channel processor
4051 path loss calculator
4053 transmit power setter
4055 power head room controller

1. A mobile station apparatus communicating with at least one base station apparatus, the mobile station apparatus comprising:
a first reception processing unit that receives a signal from the base station apparatus;
a path loss calculating unit that calculates path loss on the basis of a reference signal received by the first reception processing unit;
a transmit power setting unit that sets desired transmit power of an uplink signal using the path loss calculated by the path loss calculating unit; and
a power head room control unit that generates power head room that is information concerning a margin of the transmit power using the desired transmit power set by the transmit power setting unit to control transmission of the power head room,
wherein the power head room control unit determines to transmit the power head room upon switching of a kind of the reference signal used in the calculation in the path loss calculating unit.

2. The mobile station apparatus according to claim 1,
wherein the reference signal is of a kind of either of a Cell specific Reference Signal (CRS) and a Channel State Information Reference Signal (CSI-RS).

3. The mobile station apparatus according to claim 1,
wherein the reference signals of different kinds are Channel State Information Reference Signals (CSI-RSs) of different configurations.

4. The mobile station apparatus according to claim 1,
wherein the reference signals of different kinds are arranged in different downlink subframes.

5. A communication method used in a mobile station apparatus communicating with at least one base station apparatus, the method at least comprising the steps of:
receiving a signal from the base station apparatus;
calculating path loss on the basis of a reference signal that is received;
setting desired transmit power of an uplink signal using the calculated path loss; and
generating power head room that is information concerning a margin of the transmit power using the desired transmit power that is set to control transmission of the power head room,
wherein it is determined to transmit the power head room upon switching of a kind of the reference signal used in the calculation.

6. The communication method according to claim 5,
wherein the reference signal is of a kind of either of a Cell specific Reference Signal (CRS) and a Channel State Information Reference Signal (CSI-RS).

7. The communication method according to claim 5,
wherein the reference signals of different kinds are Channel State Information Reference Signals (CSI-RSs) of different configurations.

8. The communication method according to claim 5,
wherein the reference signals of different kinds are arranged in different downlink subframes.

9. An integrated circuit that is mounted in a mobile station apparatus communicating with at least one base station apparatus and that causes the mobile station apparatus to carry out a plurality of functions, the integrated circuit at least comprising the functions of:
receiving a signal from the base station apparatus;
calculating path loss on the basis of a reference signal that is received;
setting desired transmit power of an uplink signal using the calculated path loss;
generating power head room that is information concerning a margin of the transmit power using the desired transmit power that is set to control transmission of the power head room; and
determining to transmit the power head room upon switching of a kind of the reference signal used in the calculation.

10. The integrated circuit according to claim 9,
wherein the reference signal is of a kind of either of a Cell specific Reference Signal (CRS) and a Channel State Information Reference Signal (CSI-RS).

11. The integrated circuit according to claim 9,
wherein the reference signals of different kinds are Channel State Information Reference Signals (CSI-RSs) of different configurations.

12. The integrated circuit according to claim 9,
wherein the reference signals of different kinds are arranged in different downlink subframes.
